(19) United States
(12) Patent Application Publication
(10) Pub. No.: US 2026/0238483 A1
(43) Pub. Date: Aug. 13, 2026

(54) PROCESS FOR GENERATING TOKENS FROM A SET OF INPUT DATA OF VARYING LENGTH

(71) Applicant: PRIVITAR LIMITED, London (GB)

(72) Inventors: Paul MELLOR, London (GB); Sasi Kumar MURAKONDA, London (GB)

(21) Appl. No.: 19/161,297

(22) PCT Filed: Mar. 4, 2024
(86) PCT No.: PCT/GB2024/050574

§ 371 Date: Sep. 1, 2025

(30) Foreign Application Priority Data
Mar. 2, 2023 (GB) 2303055.4
Mar. 16, 2023 (GB) 2303857.3

(51) Int. Cl. H04L 9/32; G06F 21/16

(52) U.S. Cl. CPC H04L 9/3213; G06F 21/16; H04L 9/3236

(57) ABSTRACT

There is provided a computer implemented process for generating tokens from a set of input data that includes input values of varying length, in which the process includes the step of generating tokens from the set of input data. The tokens have lengths that exhibit a substantially similar distribution as the distribution of lengths of the set of input data.

### BACKGROUND OF THE INVENTION

### 1. Field of the Invention

The field of the invention relates to a computer implemented methods or processes for generating tokens from a set of input data of varying length and for embedding a digital watermark within the generated tokens; and to related computer implemented devices or systems.

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### 2. Discussion of the Prior Art

Tokenisation involves the substitution of private identifiers, such as an individual's credit card number or social security number, with a token that is generated to conform to some user-specified format and has a 1:1 relationship with the original private identifier. This same token is always used in place of the same identifier, and never used for any other identifier.

Digital watermarking relates to the process of embedding information called a digital watermark into a digital content, while preserving the functionality of the digital content.

WO2017093736A1 discloses a process of altering an original data set by combining data anonymization and digital watermarking. In particular, the anonymisation of the original data set can be achieved using a tokenisation technique, where tokenised values are generated with a regular expression. However, the regular expression must be known at the extraction time of the watermark. Further, the tokenisation technique used includes a central vault which can cause problems for customers who have high throughput needs, or a requirement to consistently tokenise values in remote locations.

There is a need for a process in which digital watermarking is applied to tokenised data with no knowledge of the regular expression that was used to tokenise the data. In addition, a system that scales to be able to individually watermark any number of data releases is needed.

Additionally, tokenisation techniques have proven effective in handling fixed data structures, such as credit card numbers or zip codes. However, tokenising input data of varying lengths, such as names or email addresses, present a complex challenge. There is therefore a need for a process that can provide a robust solution for handling input data of varying lengths.

Additionally, there is a need for a process of embedding information or a digital watermark into digital content generated using Generative AI, such as within an image or video frame or audio or text.

Reference is made to WO2017093736A1, the contents of which are incorporated by reference.

### SUMMARY OF THE INVENTION

An aspect of the invention is a computer implemented process for generating tokens from a set of input data that includes input values of varying length, in which the process includes the step of generating tokens from the set of input data, the tokens having lengths that exhibit a substantially similar distribution as the distribution of lengths of the set of input data.

Another aspect of the invention is a computer implemented process for embedding a digital watermark within tokenised data, the process comprising the steps of:
(a) generating tokens from a set of input data that includes input values of varying length, in which tokens are generated with lengths that exhibit a substantially similar distribution as the distribution of lengths of the set of input data, and
(b) embedding the digital watermark within the set of generated tokens.

Another aspect of the invention is a computing device or system adapted to generate tokens from a set of input data that includes input values of varying length, the device or system comprising a processor that is configured to generate tokens from the set of input data, the tokens having lengths that exhibit a substantially similar distribution as the distribution of lengths of the set of input data.

Another aspect of the invention is a computing device or system adapted to embed a digital watermark within tokenised data, the device or system comprising a processor that is configured to:
(a) generate tokens from a set of input data, in which tokens are generated with lengths that exhibit a substantially similar distribution as the distribution of lengths of the set of input data, and;
(b) embed the digital watermark within the set of generated tokens.

### BRIEF DESCRIPTION OF THE FIGURES

Aspects of the invention will now be described, by way of example(s), with reference to the following Figures, which each show features of the invention:

FIG. 1 shows a histogram of token counts within each bin.

FIG. 2 shows a diagram that represents a space of possible inputs

FIG. 3 shows a diagram that represents a token space with watermark tokens uniformly distributed across the token space.

FIG. 4 shows a diagram illustrating the algorithm that maps an input space to a token space based on two encryption schemes.

FIG. 5 shows a diagram (5A) with 53 watermark tokens distributed across a token space of size 400 and another diagram (5B) with the token space divided into 53 segments.

FIG. 6 shows a diagram illustrating the process for a couple of the example segments in which one contains an actual watermark token and one does not.

FIG. 7 shows diagrams illustrating an input space and a token space.

FIG. 8 shows a diagram illustrating the steps for determining the index of a value within the input space.

FIG. 9 shows a diagram illustrating the encryption of subspace index.

FIG. 10 shows a diagram illustrating how to find the token space segment that the inputs map to.

FIG. 11 shows a diagram illustrating how to search a segment to find a desired token.

FIG. 12 shows a diagram illustrating the output with the final token ordinal.

FIG. 13 shows a diagram illustrating the hash space divided into equal width bins.

FIG. 14 shows a diagram illustrating the process of extracting a watermark.

FIG. 15 shows a diagram illustrating the process of extracting a watermark, when multiple hash functions are used.

FIG. 16 shows a diagram illustrating the process of extracting a watermark on a set of parallel hash array.

FIG. 17 shows a diagram illustrating the parameters of the algorithm.

FIG. 18 shows three histograms of token counts within each bin for the case of a ‘pure’ watermark (18A), a watermark with noise (18B), and two mixed watermarks.

FIG. 19 shows a diagram illustrating the extraction token count requirements as the number of data releases grows.

FIG. 20 shows a plot of the tokens required as a function of the percentage of input noise.

FIG. 21 shows a diagram illustrating extraction token count requirements as the number of data releases grows.

FIG. 22 shows a plot of the tokens required as a function of the percentage of input noise.

FIG. 23 shows a plot of the normalized computation time for watermark embedding.

FIG. 24 shows a plot of the normalized computation time for watermark extraction.

FIG. 25 shows the ultimate outcome of a watermark extraction performed with a confidence level of 95%, as the number of tokens processed in the extraction increases.

FIG. 26 shows the outcome of a watermark extraction performed with a confidence level of 99.9%.

FIG. 27 shows the outcome of a watermark extraction with random noise progressively added.

FIG. 28 shows a diagram plotting false positive occurrence percentage for the same experiments.

FIG. 29 shows a diagram illustrating the number of tokens required to achieve confidence.

FIG. 30 shows results of an experiment with two data release watermarks mixed together.

FIG. 31 shows results of an experiment with three data release watermarks mixed together.

FIG. 32 shows a diagram illustrating the process of extracting a watermark, when multiple hash functions are used and a different bin in each hash function for the data release.

FIG. 33 shows a diagram depicting the watermarking algorithm that maps a two-dimensional input space to a token space based on the deterministic tokenization scheme.

FIG. 34 shows a graph illustrating the character length distribution of common surnames taken from a 1990 US Census survey.

FIG. 35 shows a graph illustrating the corresponding tokens distribution when plotted in a chart with linear scale axes.

FIG. 36 shows a graph of the length of token generated for the first length, 2, using a standard deviation of ⅓ of the range.

FIG. 37 shows a graph of the length token generated as a function of the number of tokens of that length allocated for the 2 character input.

FIG. 38 shows a diagram of the ciphertext ordinal index as a function of the region of the ciphertext space it falls within.

### DETAILED DESCRIPTION

An implementation of the invention proposes a computer implemented process of incorporating digital watermarking on top of deterministic tokenization.

We may refer to the following terms throughout the description.

Input space—a space of all possible inputs from a set of original data that might need to be tokenised. The input space may be described using a regular expression. For example, when tokenising credit card numbers, a simple input space definition might be “[0-9]{16}”—16 decimal digits (this example ignores the complication that not all prefixes are valid, and the Luhn digit check, etc).

Token space—similar to the above, this is the space of all possible tokens that can be returned.

Tokenised data—data where the input values have been replaced with tokens.

Data release—generally refers to any release of tokenised data to a particular recipient for a particular purpose. Each data release is therefore associated with its own digital watermark. The digital watermark may be a number or other ‘ID’ which is stored in a watermark registry alongside metadata. Hence by extracting the watermark from the release, any metadata associated with the data release may also be obtained. Metadata may include for example the one or more recipients allowed to receive the data release, the purpose or intended use of the data release, how long the one or more recipients are legally allowed to retain the data, with whom they are allowed to share the data.

Watermark tokens—as will be apparent in the following description, the hash-based watermarking scheme used works by not returning any tokens that hash to a value that falls within the watermark bin—these tokens are referred to as the watermark tokens. The token space therefore consists of the watermark tokens (those that hash to the watermark bin) and the non-watermark tokens (those that hash to other bins).

Watermark inputs—with deterministic tokenization, a 1:1 mapping from all inputs to all tokens has to be fixed. Some of these inputs will therefore be mapped to the watermark tokens, but we don't want to return these tokens. The crux of the scheme therefore is that we influence the mapping so that the watermark tokens are mapped to inputs that we don't think are likely to occur—and we call those inputs the watermark inputs. As an example, if we were tokenising credit card numbers using the regular expression described above, then we might choose our watermark inputs to be those numbers that start with 0000, since these are not used for real credit card numbers so we won't encounter them. As described below, the mapping of inputs to tokens is performed on the fly by the algorithm.

### Watermarking

Previous watermarking technique, as disclosed in WO2017093736A1, allows the generation of these tokens to be controlled so that a pattern is embedded within them. This pattern can be varied for each data release and allows a unique identifier for the release to be embedded within and across the data itself. This identifier can be used as a pointer to an arbitrary store of metadata about the data release—the intended recipient and purpose of the release, its lineage including the privacy treatments that have been applied to it, the date by which the data must be deleted, etc. This embedded pattern is probabilistic and is extractable from a sample of the generated tokens rather than being reliant on any individual tokens, so that it is still extractable from a sufficiently large subset of a data release.

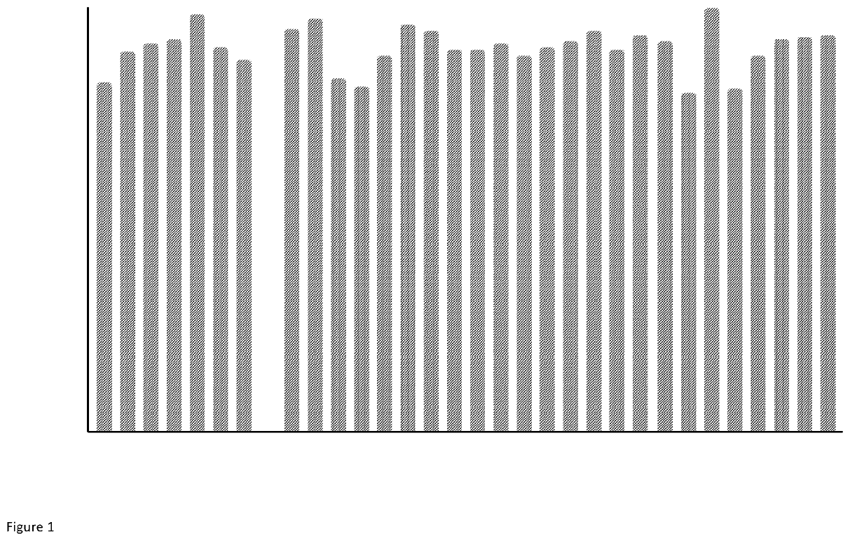

A rejection sampling based algorithm works by rejecting potential tokens (and instead generating another token) according to some pattern, and then a corpus of watermarked data is scanned to reconstruct the pattern and thus learn the watermark. The pattern embedded by the algorithm is based on the hash of the tokens—the hash space is divided into bins, each of which is assigned to a data release and then when watermarking a data release we wish to reject any tokens that hash to a value that falls within the current data release's hash bin (with each data release being assigned a different slice of the hash space). If we then scan the watermarked data, hashing the tokens and building a histogram of token counts within each bin, as shown in FIG. 1, we can identify the empty bin and thus the data release that the watermark belongs to.

Vault Based Vs. Deterministic (Vaultless) Tokenisation

The process described above works with vault based tokenisation because we get to choose the token to assign to an input at the point of tokenising that input. As long as we encounter fewer inputs than there are possible tokens we don't have to return every token, and we can choose to never return those tokens that hash to the watermark bin.

Rejection sampling has therefore been achieved with a tokenisation system that generates tokens matching the required format randomly, storing the generated token in a persistent data store (the “token vault”). At the point of generating a token, if a candidate value is generated that should be rejected then another can simply be generated. However, this reliance on a central token vault can cause problems for customers who have high throughput needs, or a requirement to consistently tokenise values in remote locations.

Because of this, it may be preferred to use a tokenisation scheme that is algorithmic (e.g. based on a format preserving encryption cipher) and thus entirely deterministic. Under such a scheme, for every possible (i.e. matching the defined format) input there is a mapped token—it is therefore assumed that it is not possible to perform rejection sampling watermarking with this system, if an input that is mapped to a token that should be rejected is encountered, there is no option but to release that token. This is due to the fact it's not possible to choose another token, because that other token would be 1:1 mapped to a different input and this would ultimately break the tokenization scheme. A solution to this problem is presented in the following paragraphs.

### Watermarking Deterministic Tokenisation

An implementation of the invention is a method for making rejection based watermarking work on top of deterministic tokenisation. It uses the observation that the probability of encountering a particular input is often not uniform across the input space, and endeavours to assign those tokens that should be rejected to those inputs that are least likely to be encountered. This is achieved using a combination of two format preserving encryption ciphers—one that maps the least commonly encountered inputs to the ‘rejected’ tokens or watermark tokens, and the other that maps the remaining (majority) of inputs to the other tokens or non-watermark tokens.

Advantageously, the digital watermark is embedded within the set of generated tokens and not in any metadata or redundant data.

With deterministic tokenisation, as the name implies, we have a predetermined mapping of which token will be returned for each input before tokenisation starts. There is a single regular expression defined that represents both the tokens that will be returned and the inputs that will be encountered, and this mapping is defined in terms of this expression—for example, it may be that with the expression [A-Z] that input ordinal 5 (i.e E) maps to token ordinal 10 (i.e. J).

At the point of tokenising an input, we have no flexibility to choose any token other than the mapped one, regardless of whether or not it falls within the hash bin that we would like to remain empty.

To embed a perfect watermark we need to avoid ever returning a token that hashes to a value that falls within the slice of the hash space that has been nominated as the bin assigned to the data release (hereafter referred to as a watermark token). But the watermarking extraction algorithm is tolerant to the addition of some level of random noise. Such noise decreases the level of confidence reported for the watermark match, which has the effect of requiring more tokens to be scanned before reaching the required confidence, but does not prevent successful extraction (the relationship between noise and the number of tokens required to reach a confidence threshold is well understood).

Therefore, to embed a watermark we need to meet two criteria:
1. There need to be some possible values that are encountered less frequently than the other values (the difference in relative frequencies will dictate the level of noise in the final watermark—if there are enough values within the input space that never actually appear in the data then we can return a perfect watermark, otherwise there will be some level of noise present).
2. There needs to be some way of assigning the watermark tokens to these inputs (or, equivalently, assigning the non-watermark tokens to the inputs that do appear).

When using a token vault these criteria are met—we organically discover which inputs exist in the data (we are never asked to tokenise an input that never appears) and we are able to choose which token to assign to an input at the point of tokenisation. To make watermarking work with deterministic tokenisation, we need to engineer a way for them to hold there too.

Vaultless tokenization has several advantages, such as in distributed deployments where it is often not possible to call out to a centralised vault. In comparison, vault-based tokenisation distributed around the globe requires the raw data to be sent to a token vault alongside the tokens, because both have to be stored in a centralised vault. But this sending of raw identifiers from one jurisdiction to another is often contrary to legal directives or regulations.

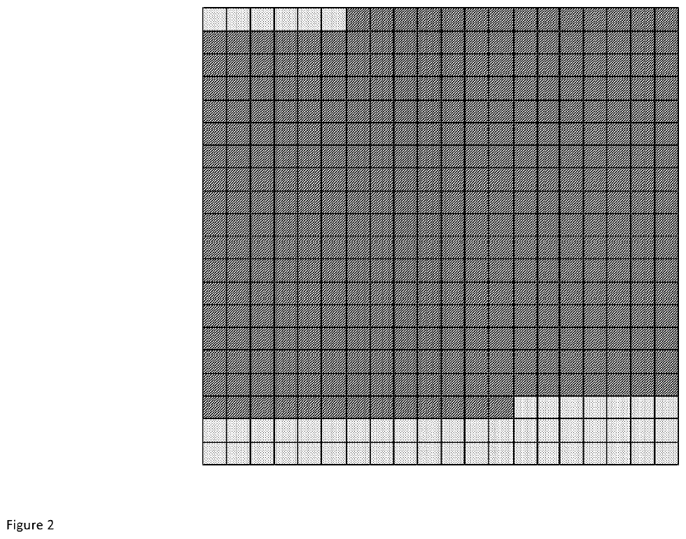

FIG. 2 shows a diagram that represents a space of possible inputs (each possible input being a small square representing an ordinal within the total space of 400 possibilities) where some of the inputs (shown in light grey) have been identified as those that are less likely to be observed, and therefore should be mapped to watermark tokens.

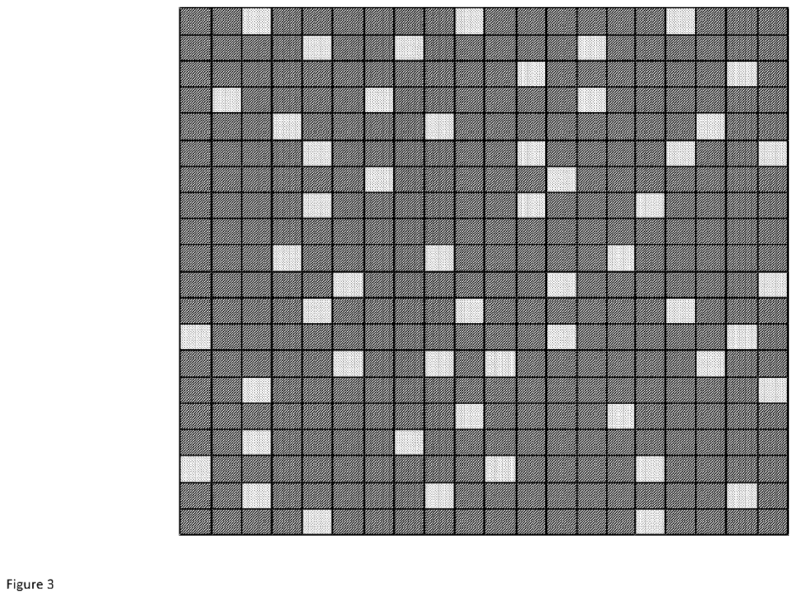

We wish to map these inputs (which we refer to as the watermark inputs) to those tokens that hash to a value that falls within the data release watermark bin (the watermark tokens). A cryptographic hash function (based on a secret ‘watermarking key’) used within the watermarking algorithm will distribute hashes uniformly across the hash space. This implies that the hashes falling within a range of the hash space are from values drawn uniformly from across the value space—i.e. that the watermark tokens will be uniformly distributed across the token space, as shown in FIG. 3.

However, the mapping from an input to its token is determined by the underlying format preserving encryption cipher and is a permutation that is indistinguishable from random—it is not possible to hard-wire mappings into the cipher (at least, not without devising one's own non-standard and inevitably insecure encryption cipher). To achieve a scheme where a subset of the input space maps to a subset of the token space, we have to treat the subspaces as distinct spaces with their own separate encryption cipher. To encrypt a value, we follow these steps:
1. Determine which of the distinct subspaces contains the value;
2. Encrypt the value using the cipher for that space, resulting in another index within the same space;
3. Map this output index back on to the global token space to find the resultant token.

To implement this solution, we need to solve two problems:
1. Determining which inputs are the watermark inputs that should be mapped to the watermark tokens
2. Determining which tokens are watermark tokens (i.e. hash to a value within the watermark bin)

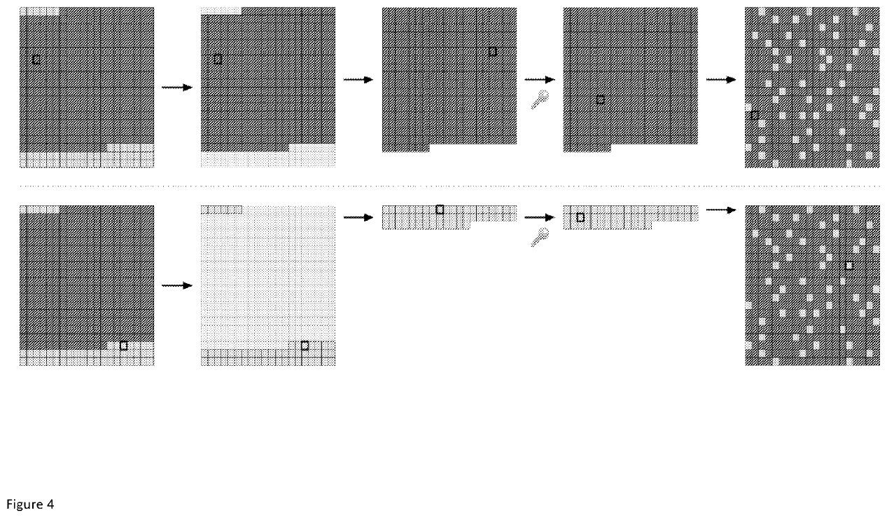

FIG. 4 illustrates these steps.

Hence each format preserving encryption cipher uses a secret key. A further secret key—the watermarking key—is used by the cryptographic hash function in order to prevent an attacker learning whether a token is a watermark token or not.

### Modelling Input Value Distributions

To be able to exploit a distribution in the values appearing within input data sets, we first need to know what this distribution is—armed with this information, we know which inputs appear either rarely or never, and can endeavour to assign the watermark tokens to those inputs. Examples of approaches to this are now described:

### Describing the Data

In some situations, there exists some a priori knowledge of the structure of the input data that can be used to describe regions of the input space that will never be encountered. For example, not all numbers that conform to the Social Security number structure are actual Social Security numbers because numbers with 666 or 900-999 in the first digit group are never allocated.

Making Assumptions about the Data

If the data has some external meaning—examples include names, email addresses, salaries—then it is likely that it may fit some general heuristics about data that we can use to make an educated guess about where to allocate the watermark tokens. For example, in English language text the digraph “th” is likely to be much more frequent than “qz”, and for many numeric distributions the probability density function is often low at the upper end of the range.

We can use this to allocate the watermark tokens—for example, if presented with a regular expression of [A-Z][a-z]{1,9} we could define a range such as (Qz|Jq|Jx|Qx)[a-z]{0,8} to capture those inputs that we expect to appear least frequently (or never).

Benford's law states that in many numeric data sets the leading digit is likely to be small, and the probability of a particular digit being the leading digit decreases logarithmically as the digit increases. Benford's law generally applies to datasets that have a lognormal distribution and so its direct usage is probably not general enough, but we can generalise to say that for numeric data that falls within some defined range, the probability density function is often low at the upper end of the range. This holds for the lognormal distributions spanning several orders of magnitude that satisfy Benford's law, as well as for normal distributions (e.g. height), distributions with long tails (e.g. salary), and monotonically increasing values (e.g. identifiers drawn from database sequences). Therefore, simply allocating the watermark tokens to the upper end of the numeric range can be expected to give good results for a lot of data sets.

### Scanning the Data

If nothing is known of the input distribution in advance, and if the assumptions in the previous section do not hold, then it may be possible to infer the input distribution by scanning the data and observing it. Note however that this may be a weaker solution to the previous techniques because the configuration has to be finalised from a scan of the current data, but there are no guarantees that future data will have the same distribution. For example, if the data was drawn randomly from within a space with uniform probability, then we may be able to find regions within the space with no values to assign watermark tokens to, but future values may fall within these ranges (whereas Social Security numbers will never contain the special numbers, and data that follows Benford's Law will continue to do so in the future).

### Identifying Watermark Tokens

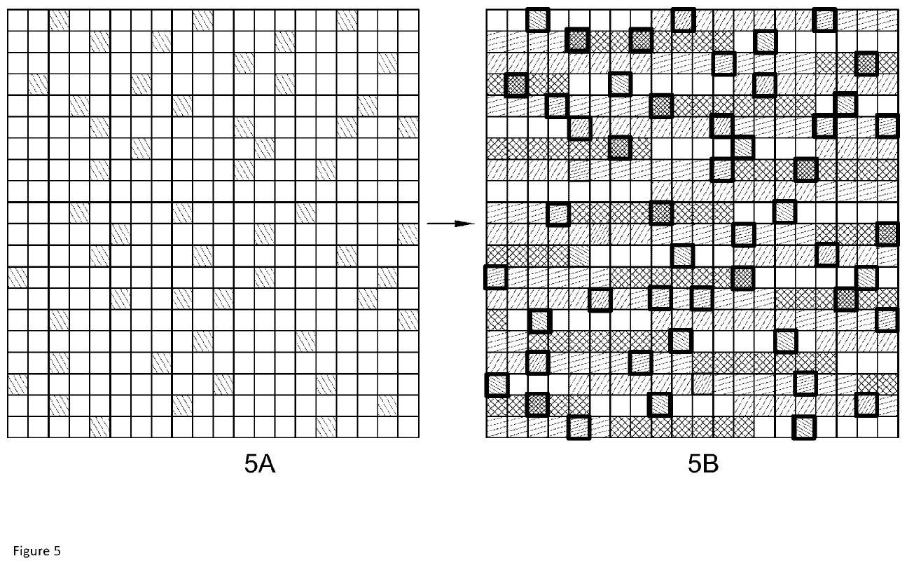

The watermark tokens are defined as being those tokens that hash to a value that falls within the watermark bin. Since a hash function is a one-way function, there is no way to be able to take the watermark bin hash values and find the tokens that will hash to them. The only way to find if a token's hash falls within the bin is to hash it and find out, and attempting to brute force the entire token space to find all of the watermark tokens is infeasible for all but the most modest token spaces. Instead, we use the fact that the watermark tokens will be uniformly distributed across the token space. This means that if we divide the token space into segments then on average these segments will contain equal numbers of watermark tokens—for example, if we divide the space into as many segments as there are watermark tokens then on average each segment will contain a single watermark token (some segments may not contain any, and some will contain multiple, but on average each segment will contain a single watermark token). As an example, FIG. 5A shows a diagram with a distribution of 53 watermark tokens across a token space of size 400. FIG. 5B shows the token space divided into 53 segments (29 of size 8, and 24 of size 7) filled with different patterns to demark the segments (with the watermark tokens within a segment highlighted with a thicker line). This gives us 37 segments containing exactly one watermark token, 8 segments containing two watermark tokens, and 8 segments containing no watermark tokens.

Since we have divided the input space into those inputs that we want to map to normal tokens and those that we want to map into watermark tokens, we can define a segment size that gives us as many segments as there are watermark inputs. We then define that each segment contains exactly one nominated token that we will assign to a watermark input. We would like to nominate a true watermark token (i.e a token that hashes to the watermark bin), but we do not know in advance which token within the segment this is (nor even whether the segment does in fact contain a watermark token). When we need to choose the nominated token, we search the segment to find the first token within it that is a true watermark token (falling back to returning the last token within the segment if none are).

When we need to choose the nominated token, we search the segment using the following process:
1. Determine a starting point within the segment—we want this to be deterministic (so that we get the same answer for the segment every time) but different for each segment. To do this, we seed a pseudorandom number generator (PRNG) with the segment index and use it to choose one of the indices within the segment.
2. Test the token at this starting index to see if it is a watermark token (i.e. whether it hashes to a value that falls within the watermark bin). If it is, then this becomes the segment's nominated token.
3. If the token was not a watermark token, then proceed to testing the next token. Continue this process (looping around at the end of the segment) until we either find a watermark token, or we reach the starting point again.
4. If we reach the starting point again without finding a watermark token, then we nominate the final token that we tested in the segment (i.e. the last token we encounter after traversing all tokens in the segment with the wraparound). This is why we choose a different starting point for each segment—if we started at the same point for each then we'd return the same token relative to the segmentation for each segment (i.e. the nominated tokens would be regularly spaced within the token space).

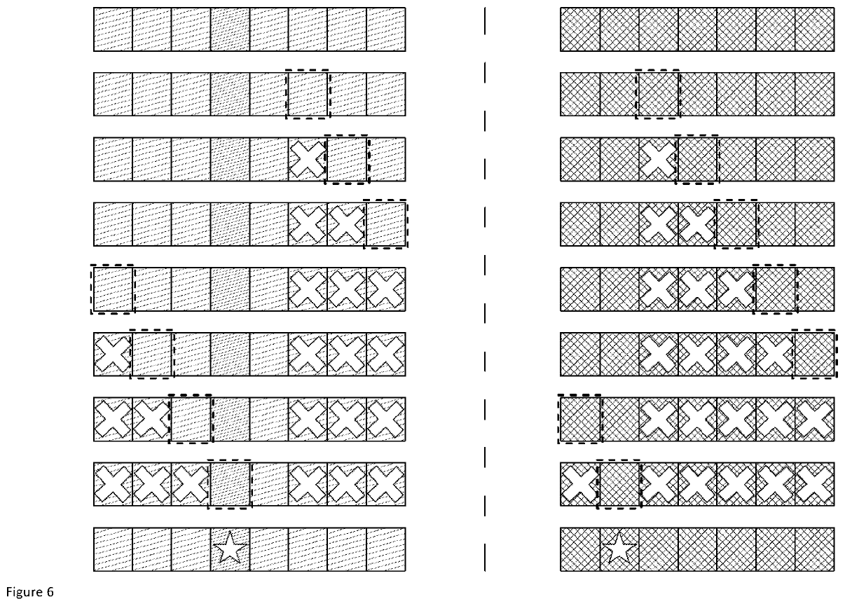

FIG. 6 shows a diagram illustrating the process for a couple of the example segments in which one contains an actual watermark token and one does not.

Note that there may be two ways in which this system may lead to imperfect watermark input→watermark token and non-watermark input→non-watermark token mappings:
1. If the segment contains multiple actual watermark tokens (tokens that hash to the watermark bin), then only one of them will be assigned to a watermark input and the others will be returned for a non-watermark input. This will result in noise being added to the watermark.
2. If the segment contains no watermark tokens, then the watermark input will be assigned a token that is not actually a watermark token. Note that this is benign—the watermark input may (by definition) be rarely encountered anyway and returning a non-watermark token does not introduce any noise.

As we can see, the first outcome weakens the embedded watermark, and is more likely to occur when we declare too few watermark inputs. The number of watermark inputs we declare drives the number of nominated tokens we consider, but this is independent of the number of watermark tokens that actually exist. The number of watermark tokens depends on the number of hash bins and the token space size. If the number of watermark inputs is less than the number of watermark tokens, then it is clear that this scenario will occur.

The second outcome is benign, unless its occurrence also implies the occurrence of the first outcome—for example, if the declared number of watermark inputs exactly matches the actual number of watermark tokens then it is likely that the segmentation will give imperfect results, and the fact that some segments produce outcome two means that others must produce outcome one.

The optimal strategy is achieved when the number of watermark inputs exceeds the number of watermark tokens by a comfortable margin such that the segments are small enough that the probability of a segment containing multiple watermark tokens is small. But this should not be achieved by artificially inflating the number of watermark inputs since this may lead to assigning watermark tokens to inputs that are not really encountered more rarely than other inputs (and thus introducing noise to the watermark through the frequent release of watermark tokens).

### Security

If an attacker was able to determine that a particular token is a watermark token, then she would know that the corresponding input is drawn from within the space of less frequently encountered inputs—an unacceptable leak of information. However, because the algorithm uses a secret watermarking key when embedding the watermark (using a cryptographic hash function) this kind of inference is impossible without access to this key and an attacker can learn nothing more from the tokens when compared to a vault based solution.

A worked example is now described to illustrate the complete algorithm.

### Worked Example

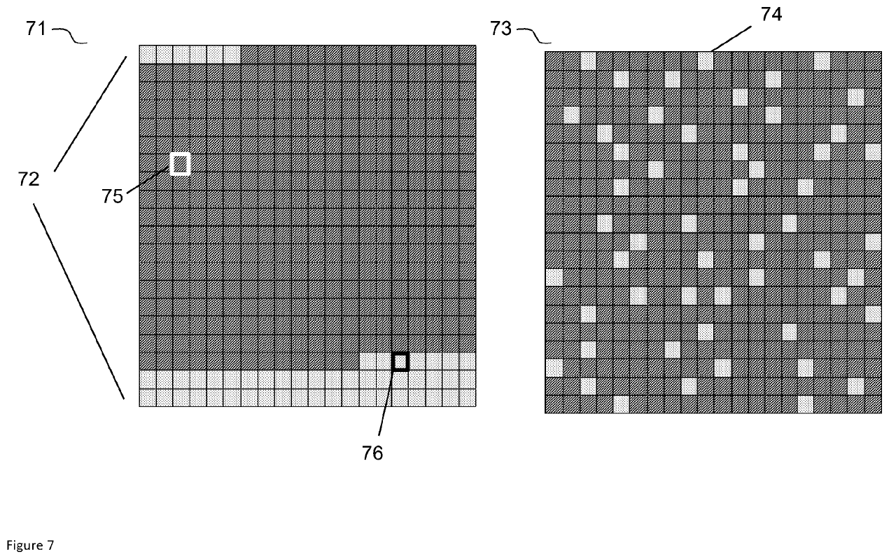

This section works through the steps of the complete algorithm for two scenarios simultaneously, an input that falls in the watermark inputs region and one that does not. We use the same example scenario as discussed above. FIG. 7 shows diagrams illustrating an input space and a token space. The left pane shows an input space 71, with declared watermark inputs 72. The right pane shows the token space 73, with the distribution of the watermark tokens also shown in a lighter greyscale colour 74 (though note that this is not known to the algorithm). Our example will tokenise the non-watermark input highlighted 75 (the input with ordinal 123), and the watermark input highlighted 76 (the input with ordinal 356).

Step 1: Determine the Index of the Value within the Input Space

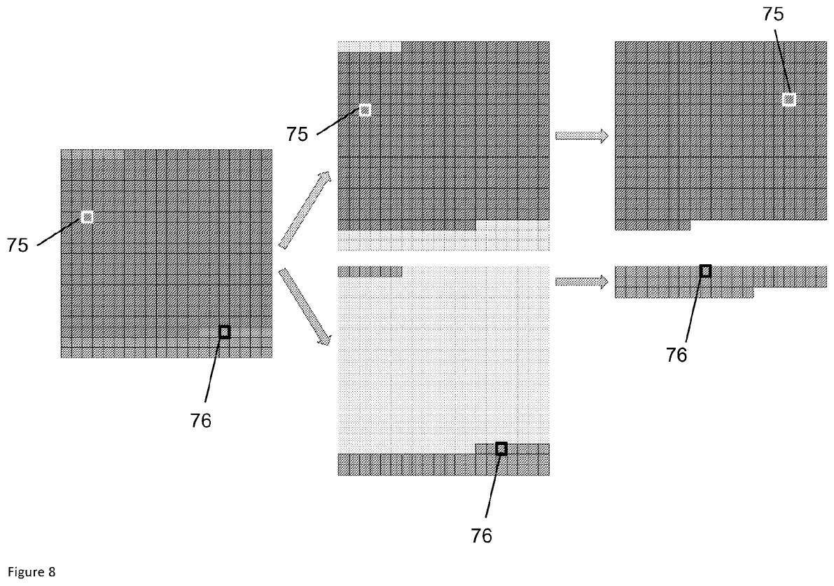

For each input, we first determine which subspace it is contained within and then its index within that space. FIG. 8 shows a diagram illustrating the steps for determining the index of a value within the input space.

In our example, the input 75 (input with ordinal 123) falls within the non-watermark inputs subspace where it has index 117, and the input 76 (input with ordinal 356) falls within the watermark inputs subspace where it has index 9.

### Step 2: Encrypt the Subspace Index

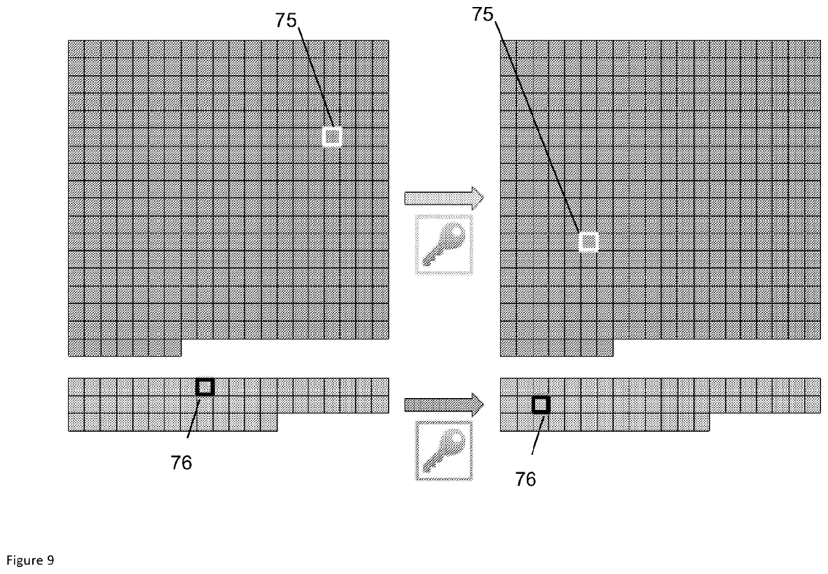

We now encrypt the input within its subspace—taking the index within this space and using a format preserving encryption method to obtain another index within the same space. FIG. 9 shows a diagram illustrating the encryption of subspace index.

In our scenario, the input 75 has index 117 within a subspace of size 347—in this example, this encrypts to index 226. The input 76 has index 9 within a subspace of size 53, which encrypts to index 23.

Step 3: Find the Token Space Segment that these Inputs Map to

We now need to find the token ordinal that these subspace indices map to. By definition, we have one nominated token per segment—since there are a total of 53 watermark inputs then this means we define 53 segments. We try to balance the size of these segments as far as possible, so we create 29 segments of size 8, and 24 of size 7.

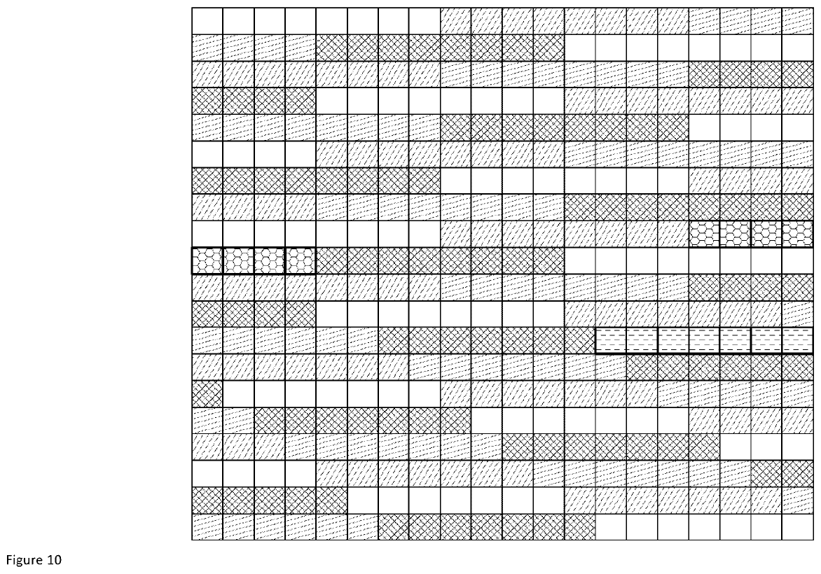

FIG. 10 shows a diagram illustrating how to find the token space segment that the inputs map to.

Since there is one nominated token per segment, then the nominated token with index 23 is obviously in the 23rd segment. To find the non-watermark token with index 226 (the 226th non-watermark token in the space), we need to skip over segments until we have passed 225 other non-watermark tokens. The first 29 segments each contain 8 tokens, one of which is a nominated token, so once we have skipped all of these we have passed 203 non-watermark tokens. The remaining segments contain 7 tokens (6 of which are non-watermark tokens) and so we need to skip a further 3 of these to bring us to a total of 221 non-watermark tokens. Therefore we can say that the non-watermark token with index 226 will be the 5th non-watermark token in the 33rd segment.

### Step 4: Search the Segment to Find the Desired Token

Having found the correct segment for each case, we now need to find the relevant token within it.

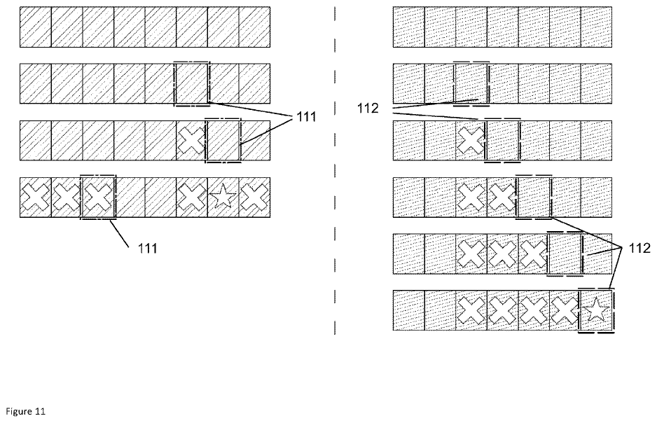

FIG. 11 shows a diagram illustrating how to search a segment to find a desired token. For the input 111, we are searching for non-watermark token with index 226, which we have calculated is the 5th non-watermark token in the 33rd segment. Our random but deterministic starting point for this segment is token 6 and we test this and find that it is not a watermark token. We then proceed to test the next token and discover that this token is a watermark token and so is the nominated token. We therefore know that to find the 5th non-nominated token we must scan past this token for a further 4 tokens. Wrapping around at the end of the segment, this tells us that the token we need is the 3rd one within the segment.

For the input 112, we need to find the nominated token within segment 23. Our starting point in this segment is index 3, and we have to seek forward testing each token until we discover that the 7th token in the segment (the 5th token we test) is a watermark token and hence the nominated token.

### Step 5: Return the Final Token Ordinal

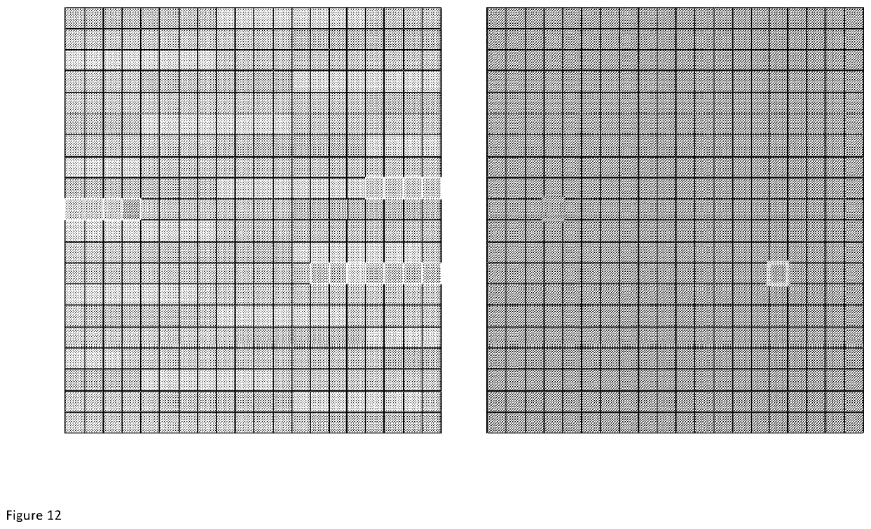

All that remains now is to map the segment tokens that we found to their ordinal within the entire token space, as shown in FIG. 12 illustrating the output with the final token ordinal.

We now finally see that the input 111 with ordinal 123 tokenises to the token with ordinal 256, and the input 112 with ordinal 356 tokenises to the token with ordinal 184.

Although the watermarking scheme has been described when combined with vaultless tokenization, it may also be extended to be combined with a vault-based tokenization. With a vault scheme, watermarking is typically an easier problem to solve as the system can be configured such that watermarked tokens are not outputted when specific inputs are encountered. However, a vault scheme stops working once more inputs are seen than there are non-watermark tokens. This is because in that case watermark tokens would have to be returned. However, the process described also provides a solution that would avoid this problem when combining watermarking with vault-based tokenization.

Further details on the algorithm are now provided.

### Algorithmic Building Blocks

### A Hash Based Watermark

To enable the watermark to be extracted from just the token (with no knowledge of how it was generated), the pattern is embedded using the hash of the tokens. Note that, although this document discusses the process in terms of “tokens”—understood to be the output of a consistent tokenisation operation—the same watermarking methodology would apply to any process that produces output containing some pseudorandomness.

For example, the output of the blurring of numeric values could be hashed and subjected to the same process.

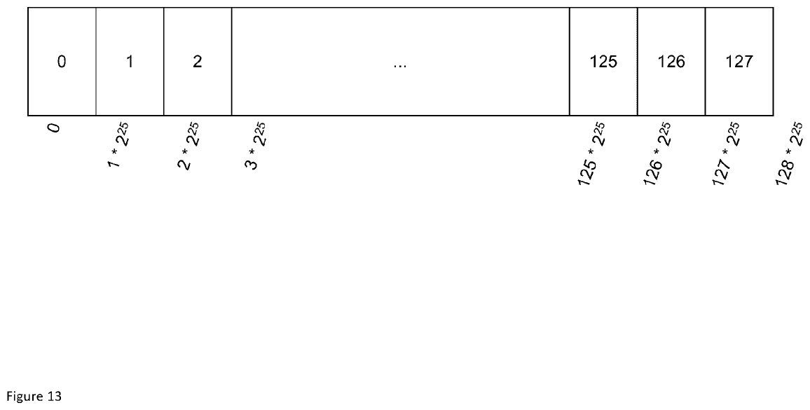

The hash space will be divided into equal width bins, and each bin will be assignable to a different data release (and therefore the number of data releases that can be watermarked is equal to the number of bins). The diagram shown in FIG. 13 depicts this for a hash function that gives an unsigned 32 bit output and 128 (2⁷) data release watermark bins (0-127). (Note that the number of bins is equal to a power of two so that the hash space is exactly divisible across the bins, giving no differences in the number of hashes per bin).

To embed the watermark for a data release, we reject any tokens that hash to a value that falls within that data release's watermark bin. The fraction of tokens rejected in this scheme is therefore 1/N, where N is the number of data release watermark bins.

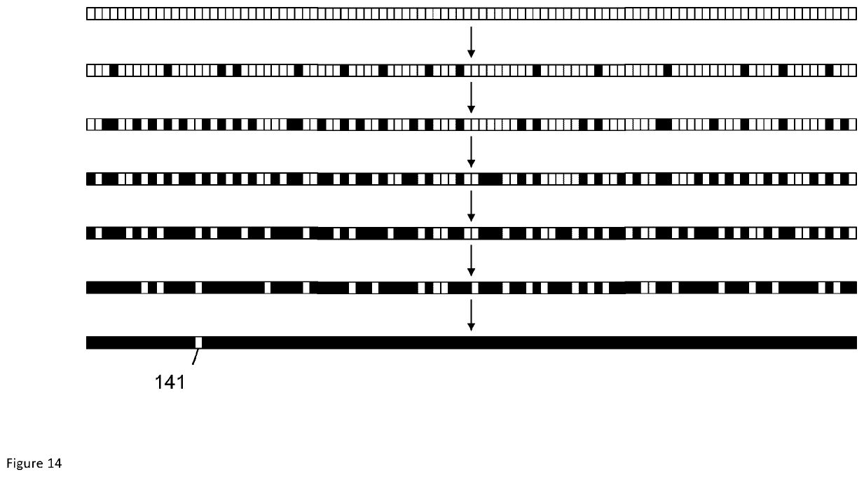

The process to extract the watermark is illustrated in FIG. 14. We hash the tokens that we encounter and increment the count of values for the bin that the hash falls within (in the diagram a bin turns black when it has at least one hash in it). Once we are left with a single empty bin 141, the bin index gives the watermark 141.

The downside of this algorithm is that as the number of distinct data releases (bins) increases, so does the number of records needed to extract the watermark. To find the watermark, we need all of the other N−1 bins to contain at least one value. This scales badly with the number of data releases.

### Extending to Multiple Hashes: The Hash Array

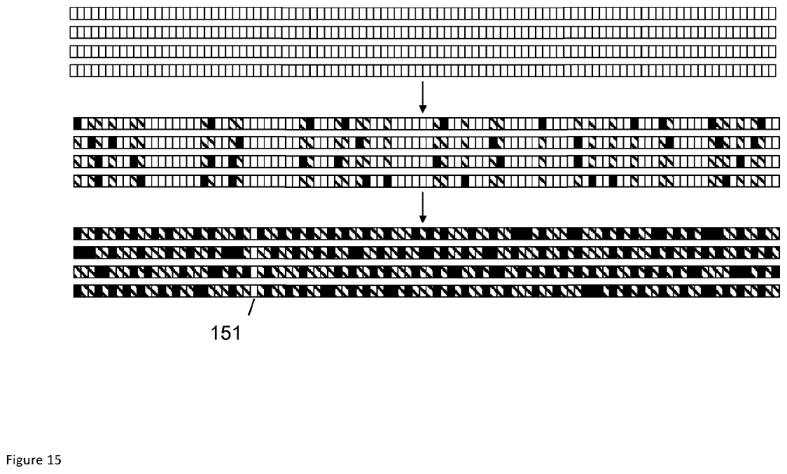

Inspired by Bloom Filters, we can use multiple hash functions and have them work together in a Hash Array structure. To embed the watermark, we reject any token that falls within the watermark bin for any of the hash functions (see below for an alternative method of using this configuration that was tested but ultimately rejected). Then when extracting the watermark, we find the single bin index that is empty in every one of the array's hash function bins—we find the empty bins for each hash function, and take the intersection of these sets, as shown in FIG. 15. When this intersection has only a single empty bin 151, we have found the watermark—but at this point each of the histograms in the array will itself still have more than one empty bin, as illustrated in the diagram (in this diagram a bin filled with a diagonal line pattern symbolises a bin that is empty for the current hash function but contains a hash—a black bin—for at least one of the other hash functions).

Note that this gives us a higher rate of token rejection (when compared with the same number of bins and a single hash function) as there are now multiple chances for a token to be rejected.

### Dynamically Scaling Data Releases: The Multi Hash Array

The Hash Array structure allows us to tune the number of bins and the number of hash functions to balance the number of supported data releases and the token rejection rate. However, the configuration must be decided up-front, which forces us to decide how many data releases we wish to support in advance and creates a finite pool of watermarks. But it is possible to dynamically scale the number of watermarked data releases by creating new instances of the Hash Array structure (each with its own hash function keys) and assigning different tranches of data releases to each. We call this structure a Multi Hash Array, and it has the following properties:
Initially, the Multi Hash Array contains just a single Hash Array instance, and so supports watermarking up to N data releases (where N is the number of Hash Array bins).
Once N watermarks have been allocated, a second Hash Array instance is created to handle watermarking the next N data releases. This new instance is given different hash function keys to the first instance, so any pattern embedded by either array appears only as random noise to the other instance.
Embedding a watermark only requires a single Hash Array instance to be used (the one that contains the data release for which the watermark is being embedded) and so computational complexity does not grow as additional data releases are watermarked.
Because the token rejection rate depends only on the number of bins and hash functions within a single Hash Array, it does not grow with the number of supported data releases.
Additional Hash Array instances can be added indefinitely, with each new instance only resulting in a modest increase in the number of rows required to extract the watermark (see later analysis).

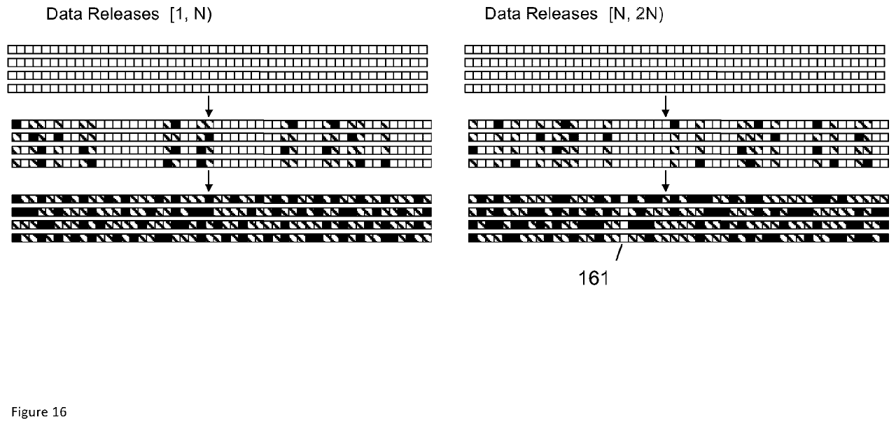

When extracting the watermark, we perform a set of parallel Hash Array extractions—one per commissioned instance. As mentioned, since each instance has its own hash function keys, the watermark pattern will appear in a single instance only, with the other instances just observing a uniform distribution of hashes (which appears as random noise). This is illustrated in FIG. 16, which shows an extraction with two such instances, one of which finds a watermark bin 161 whilst the other sees no watermark.

The partitioning of data releases that this structure imposes may also provide additional functional benefits:
We have already seen that embedding a data release watermark would only require that data release's Hash Array instance to be used, but the same is also true for a function that ‘sniffs’ a stream of data to see if a given data release watermark is present
Only the extraction of an unknown watermark requires the use of all of the Hash Array instances. However, this structure also makes it possible to narrow down the scope of the watermark detection (and hence the number of rows required) if it is known that leaked data must be from a subset of data releases (perhaps because the dataset in question was only published into some of the data releases).
If older data releases are finished with and transition out of consideration, any Hash Array instances containing only those data releases can be excluded from an extraction.

Each set of individual Hash Array keys is generated using a scheme like HKDF (a simple key derivation function KDF based on HMAC message authentication code) that allows expansion of a single master key into many different derived keys (and the ability to efficiently obtain a specific key by providing the ‘ID’ of the key in the input key material). However it would be possible to have finer grained control of keys (a different master key per tranche of Hash Arrays, or per individual Hash Array) which might also have a couple of security benefits:
Permissioning: the ability to have more granular control over which watermarks can be read where. Watermark sniffing functions may also be used to verify that watermarks exist and prevent unwatermarked data from passing, the ability to have each of these remote execution points only obtain the key for the instance containing the watermark that it expects, and not have the ability to just read any watermark, is an attractive feature.
Key Rolling: if each new Hash Array has its own key, any single Hash Array key is only in use for as long as the data releases within it are open and active (though old key versions must be kept around for as long as we wish to be able to extract watermarks generated using them).

### Number of Supported Watermarks & Token Rejection Rate

The number of unique watermarks that can be embedded and the fraction of tokens rejected (the token rejection rate) depend on the configuration parameters of the algorithm, which are:
b—the number of data release bins in each Hash Array instance
h—the number of hash functions to use in each Hash Array instance
m—the number of Hash Array instances that currently comprise the Multi Hash Array

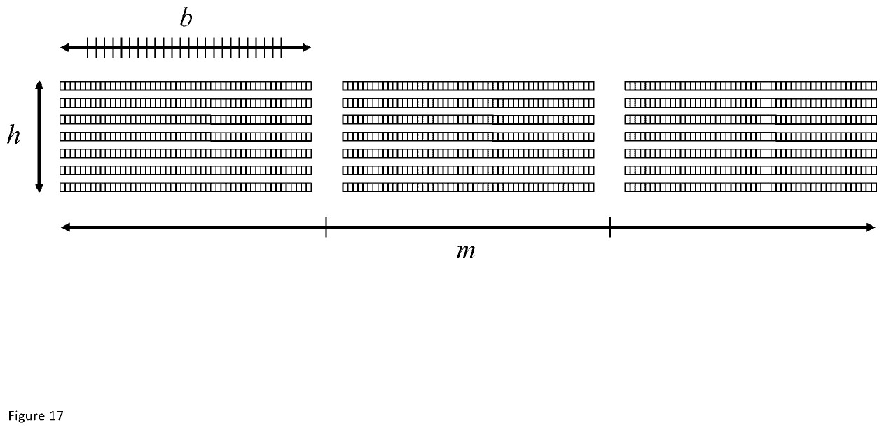

FIG. 17 shows a diagram illustrating the parameters of the algorithm.

Since one bin is used for each data release, it is clear that the number of supported data releases is given by:

$$N = m \times b$$

To embed the watermark for a data release, we reject any tokens that hash to a value that falls within that data release's watermark bin for any of the hash functions. Thus, the token rejection rate is given by:

$$fraction of token space rejected = TRR = 1 - {( 1 - \frac{1}{b} )}^{h}$$

### Extracting Watermarks

### Handling Noise: Extraction Algorithm Requirements

The data set that we are attempting to extract a watermark from may not be a clean collection of tokens with no watermark tokens: it may have been doctored through the addition of new synthetic rows; it may be a combination of outputs from several data releases; or it may be that the assumptions made about the data shape when assigning the watermark inputs were not perfectly correct). Since the watermark is embedded using a secret key, it is not possible to craft noise that will be overrepresented in any particular bin without access to this key (either directly or indirectly through the watermark extraction function), which we assume is not available to anyone trying to erase a watermark.

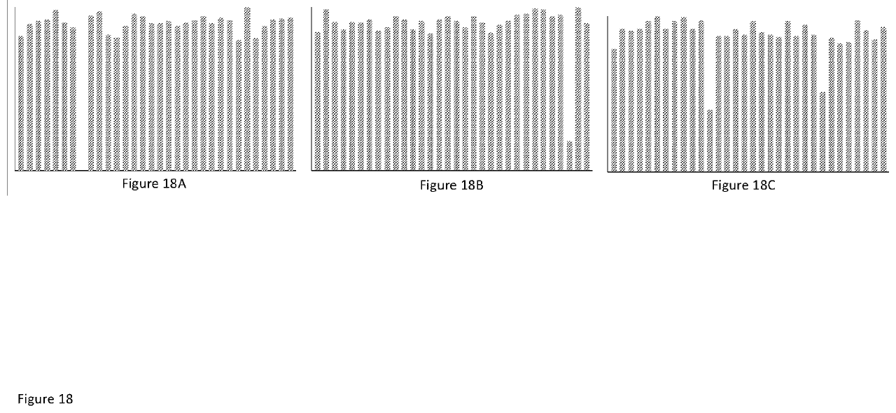

Therefore the addition of synthetic rows will manifest as a baseline level of noise on top of the pure watermark, and the combination of multiple data release watermarks will manifest as several bins each some fraction below the baseline level. FIG. 18 shows three histograms of token counts within each bin for the case of a ‘pure’ watermark (18A), a watermark with noise (18B), and two mixed watermarks.

We therefore have the following requirements for our extraction algorithm:
Must be able to extract watermarks even if a hash bin is not exactly empty
Must be able to handle multiple such bins (indicating that the data is a mix of watermarks from different data releases)
Must be able to indicate to the end user some measure of how confident we are that the data contains a particular watermark.

Any approach that attempts to find empty bins would have to loosen the definition of “empty” to handle noise and could only do this by defining some threshold fraction/count below which the bin is empty and above which it is not, and introduces an element of arbitrariness into the algorithm that is unsatisfactory.

To avoid this, the extraction method does not try to determine “which data release bins are empty?”. Instead, it reframes the question to ask, for a given data release, “are we sufficiently confident that the data contains a watermark for this data release bin?”, which it answers by calculating how likely it is that we would observe the current number of hashes in the data release bin if the watermark was not present and we were just observing noise in the bin.

By asking this question of every data release bin, we can return the data release (or data releases) that we are confident were the sources of the watermarked data (because it is sufficiently unlikely that the observed number of hashes in their bins could be down to random noise).

### Overview of the Extraction Algorithm

The watermark extraction algorithm is a simple hypothesis test at every bin, which determines whether there is sufficient evidence to reject the null hypothesis (the data does not contain a watermark for the current bin) in favour of the alternative hypothesis (the data does contain a watermark for the current bin). It does this by computing the probability of getting the observed number of hashes or lower in the current bin if the data did not contain a watermark for the bin data release. If this probability is lower than the significance level implied by the user-provided confidence level then we reject the null hypothesis that a watermark corresponding to the data release bin is not present and instead declare the presence of such a watermark.

With multiple hash functions we have multiple instances of the hash array structure. When considering a watermark bin, we sum the hashes for the bin (and the total number of hashes) across all of the hash functions.

### Testing A Data Release Bin

If the null hypothesis was true, we would expect hashes to fall into a bin as often as the other bins. However, if a watermark for the bin was present, we would expect to observe a much lower fraction of hashes in that bin compared to the other bins.

The p-value is defined as the probability of obtaining results at least as extreme as the observed results when the null hypothesis is true. In our case, this is the probability of getting the observed number of hashes (or fewer) in the bin when the data doesn't contain a watermark corresponding to the bin.

To compute the p-value, we model the hashing of tokens into different bins as a binomial distribution, where the probability of a token hashing into a given bin is 1/b when there is no watermark.

Note that when the data has a watermark that corresponds to a different bin, then this probability will be greater than 1/b. However, in those cases the actual p-value will always be less than the p-value computed with 1/b, and so we can always safely reject the null hypothesis if the computed p-value is less than alpha.

Therefore the probability of seeing k hashes in a bin after observing n hashes overall is given by:

$$Pr ( k ) = \frac{n}{k} {( \frac{1}{b} )}^{k} {( \frac{b - 1}{b} )}^{n - k}$$

Hence, the p-value for a bin containing k hashes after observing n hashes overall is given by:

$$p - value = {\sum }_{i = 0}^{k} P r ( k )$$

The smaller this p-value is, the more evidence we have for the presence of the watermark.

### The Confidence Level

The extraction algorithm takes a confidence level as user input. This is interpreted as 1−α, where α is the statistical significance of the test—that is, a bound on the probability that we will wrongly declare the presence of a watermark in data where no such watermark exists (and so the significance level provides a bound on the false discovery rate).

If the computed p-value for a bin is lower than the significance level α, then we reject the null hypothesis and declare the presence of a watermark for the bin. If it is not, we fail to reject the null hypothesis and declare that no watermark for the bin is found in the dataset.

Caution: This confidence level shouldn't be interpreted as the probability of a watermark actually being present when we reject a null hypothesis.

### Handling Multiple Bin Comparisons

When extracting an unknown watermark from data we need to test every data release bin, and for the process to be successful the decisions from all of these tests must be correct. Testing multiple bins at the same time for the presence of a watermark increases the false positive rate of the overall test beyond the false positive rate of a single test for one bin. To address this issue, we use the Holm-Bonferroni Method, which ensures that the overall error of a family of tests stays below the required error limit (whilst ensuring a higher statistical power than the standard Bonferroni correction which, for our context, means an increased ability to detect the presence of multiple watermarks simultaneously mixed into a dataset). It does this by reducing the value of a used for each test by a factor of the number of tests to be performed, which is the number of data release bins to test.

The process is to first sort the bins by p-value (lowest first) and then to use a different significance level (α) for each bin. The bin with the lowest p-value is tested first at the significance level of α/b. If the p-value for this data release is less than the required significance level, then the bin with the next lowest p-value is tested, this time using a significance level of α/(b−1). This process continues until we encounter a bin whose p-value is greater than its corresponding significance level. Hence, the values of α for extracting a combination of data release watermarks will be:

$$Possible watermark 1 : α = \frac{α}{b}$$

$$Possible further watermark 2 : α = \frac{α}{( b - 1 )}$$

$$Possible further watermark 3 : α = \frac{α}{( b - 2 )}$$

$$…$$

### How Many Tokens are Required to Detect the Watermark?

### With No Added Noise

When there is a watermark with no noise added, we have an empty bin. Hence, the p-value is just the probability of all n tokens hashing to a bin other than the current bin:

$$p - value = {( 1 - \frac{1}{b} )}^{n}$$

To detect the watermark, the computed p-value must be less than or equal to the (Holm-Bonferroni corrected) significance level, thus the minimum number of tokens is the point where:

$${( 1 - \frac{1}{b} )}^{n} = \frac{α}{b}$$

Rearranging gives the equation for computing the number of tokens required for extracting a watermark with no noise:

$${log ( \frac{b - 1}{b} )}^{n} = log ( \frac{α}{b} )$$

$$n log ( \frac{b - 1}{b} ) = log ( \frac{α}{b} )$$

$$n = \frac{log ( \frac{b}{α} )}{log ( \frac{b}{b - 1} )}$$

### Extending to Multiple Hash Array Instances & Multiple Hashes Per Instance

The only difference to the above derivations when there are multiple Hash Array instances is that there are now m×b possible watermarks, rather than just b. Repeating the steps above with the new number of tests gives the number of required tokens as:

$$n = \frac{log ( \frac{bm}{α} )}{log ( \frac{b}{b - 1} )}$$

Finally, the number of required tokens is inversely proportional to the number of hashes, and hence:

$$n = \frac{1}{h} \times \frac{log ( \frac{bm}{α} )}{log ( \frac{b}{b - 1} )}$$

### When Noise is Present

When computing the number of tokens required to extract a watermark, we need a bound on the joint probability of:
A. seeing more than a certain number of hashes in the bin if a matching watermark is present.
B. seeing fewer than or equal to that number of hashes if a matching watermark is not present.

For the noiseless case we know that the probability of A is zero (there will never be any hashes in the watermark bin if there is no noise) and so we only had to compute the probability of seeing zero hashes in a bin when the corresponding watermark is absent. But when there is noise, we need to consider both these probabilities.

We use the same notations as earlier, with the following new definitions:
H₀—Null hypothesis that watermark is absent
H₁—Alternative hypothesis that watermark is present
pᵢ—the expected fraction of hashes in bin i
nᵢ—the number of hashes in the bin i
f—expected fraction of noise

The expected fraction of hashes in the watermark bin, when the fraction of noise is f is given by:

$${p}_{i} = f \times \frac{1}{b} + ( 1 - f ) \times 0 = \frac{f}{b}$$

We know that the joint probability of two events will always be less than or equal to the sum of the probabilities of the individual events. Hence, finding the number of tokens required to read back the watermark at a given noise level is equivalent to solving for an n such that there exists a k that satisfies the below inequality:

$$P r ( {n}_{i} \leq k \vert {H}_{0} ) + P r ( {n}_{i} \geq k \vert {H}_{1} ) \leq α$$

$$where$$

$$Pr ( {n}_{i} \leq k \vert {H}_{0} ) = {\sum }_{i = 0}^{k} \frac{n}{i} {( \frac{1}{b} )}^{i} {( \frac{b - 1}{b} )}^{n - i}$$

$$Pr ( {n}_{i} \geq k \vert {H}_{1} ) = 1 - {\sum }_{i = 0}^{k} \frac{n}{i} {( \frac{f}{b} )}^{i} {( \frac{b - f}{b} )}^{n - i}$$

Getting an explicit expression for n that satisfies the above expression may be challenging, and so an estimation function instead may perform a brute force search over n and k to find the number of tokens that satisfies the above inequality.

Rows Vs. Unique Tokens

The modelling above calculates the number of tokens required to extract the watermark, but this is really the number of unique tokens as there is an implicit assumption that each token that is hashed and added to the array bins is giving us a new piece of information about the token distribution (and hence the watermark pattern embedded within it). It is only possible to embed a watermark if a sufficient diversity of inputs is encountered to allow us to return a range of tokens that touch all bins within the hash space—in the pathological case where we only ever encounter a single input, we would only ever return tokens that would populate a single bin.

It is therefore important to endeavour to add each encountered token to the extraction hash bins only once. This requires the extraction process to keep track of the tokens it has previously encountered, but it is easy to do this using a Bloom filter. Since we know the number of unique tokens that we will be required to add before we expect to be able to extract the watermark, we can size the filter appropriately—choosing a limit of 100,000 values (far in excess of the number of unique tokens we would ever expect to require) and a false positive rate of 10-9 gives a filter that requires only about 525 kb of memory (and note that the extraction process only requires a single instance of this filter regardless of the number of data releases or the algorithm configuration parameters).

### Reporting Embedded Watermark Strength

The strength of an embedded watermark may be reported to the user as part of a tokenisation job. This strength can be interpreted as the maximum confidence level that an extraction can be performed at and still correctly obtain the watermarked data release (assuming the output file is not doctored in any way), and provides an easily comprehensible summary of whether the processed data contains sufficient unique tokens to carry a watermark.

### Choosing Algorithm Parameters

### Multi Hash Array: Dynamically Growing m

As shown previously, the token rejection rate is independent of m, and the mean number of tokens needed to extract the watermark grows logarithmically with m. It therefore makes sense to treat m as a dynamic parameter—start with just a single Hash Array instance, and add more as and when additional data release watermarks are required. In this way, the token rejection rate will remain constant and the number of tokens required to extract a watermark is always at (about) the lowest value possible for the required number of data releases, growing only as new data release watermarks are released.

### Hash Array: Choosing b and h

As we've seen, the choices of b and h affect all aspects of the algorithm—the number of data releases that are supported, the token rejection rate, and the number of tokens required to extract the watermark:

$$N = m \times b$$

$$TRR = 1 - {( 1 - \frac{1}{b} )}^{h}$$

$$n = \frac{1}{h} \times \frac{log ( \frac{bm}{α} )}{log ( \frac{b}{b - 1} )}$$

However, it can be shown that these quantities are inherently related regardless of the choice of b and h by starting with the token rejection rate equation and rearranging:

$$1 - TRR = {( \frac{b}{b - 1} )}^{h}$$

$$\frac{1}{1 - TRR} = {( \frac{b}{b - 1} )}^{h}$$

$$log ( \frac{1}{1 - TRR} ) = h log ( \frac{b}{b - 1} )$$

Substituting this relation, and the equation for the number of data releases, into the equation for number of tokens gives the fundamental relationship between the quantities:

$$n = \frac{log ( \frac{N}{α} )}{log ( \frac{1}{1 - TRR} )}$$

For a given extraction confidence level, this relationship tells us that the number of tokens required to extract the watermark is a function only of the token rejection rate and the number of supported data releases and is independent of the configuration of the multi hash array.

Since the number of tokens required is reduced by rejecting more tokens, and the acceptable token rejection rate depends on the usage scenario, it implies that we may require multiple different configurations, one for each usage scenario. For our purposes we consider two common usage scenarios—the tokenisation of a bulk dataset and the tokenisation of a much smaller set of results from an interactive database query.

### Bulk Datasets

For a traditional use case of tokenising a bulk dataset, the acceptable token rejection rate is capped at 1%. The optimal configuration is therefore reached by choosing parameters that:
result in a token rejection rate as close as possible to the capped value
minimise the number of data releases, since supporting more data releases comes at a cost of more tokens required to extract the watermark. As discussed in the previous section, we can always increase m dynamically to support more data releases, but we cannot support fewer than b data releases—therefore it makes sense to minimise b so that performance is optimal initially and then slowly declines as more data releases are required, rather than have the initial performance start out lower.

Therefore the proposed configuration for this scenario is:

$$b = 1024$$

$$h = 10$$

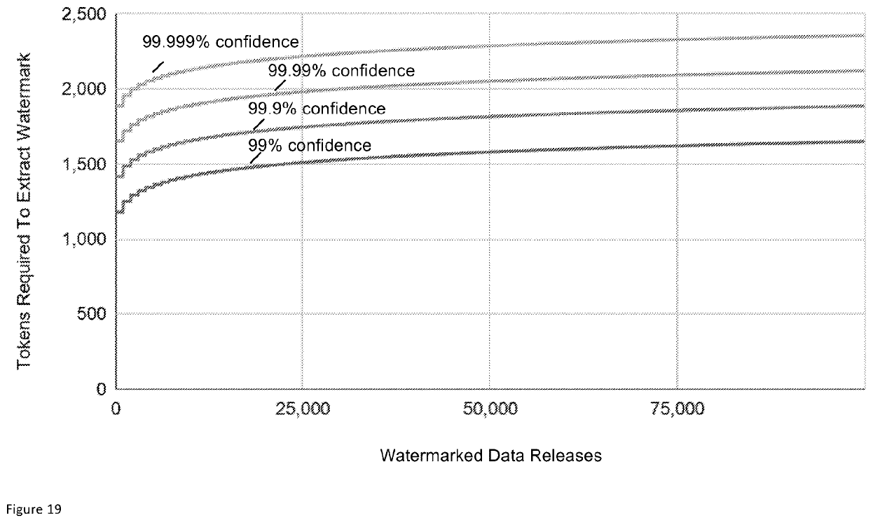

This gives a token rejection rate of just over 0.97%. FIG. 19 shows a diagram illustrating the extraction token count requirements as the number of data releases grows.

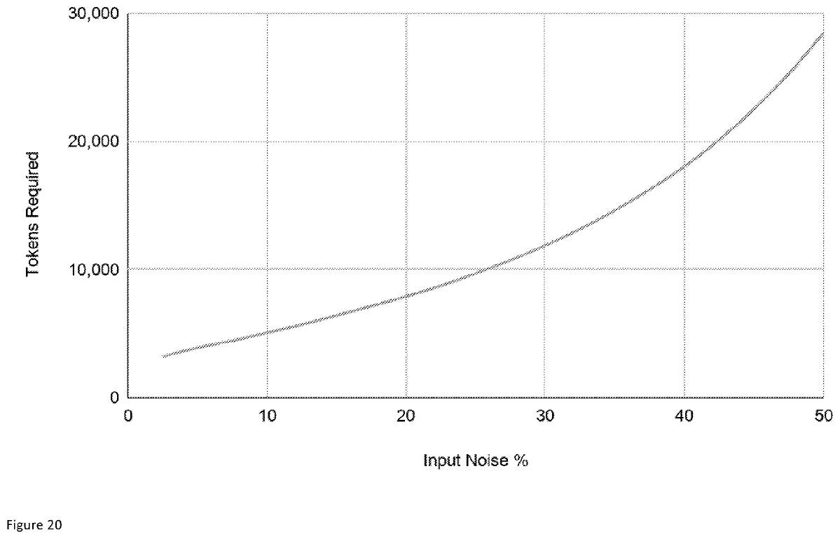

FIG. 20 shows a plot of the tokens required to extract the watermark at 99.9% confidence for the first Hash Array instance (supporting up to 1024 data releases) as a function of the percentage of input noise.

### Small Datasets

For a use case of obtaining a small sample of a dataset, either as a preview of the dataset or as the result of a selective SQL query, we can tolerate a much higher rate of token rejection (since we will have many fewer values that require tokens) but we will need to be able to embed an extractable watermark in much smaller datasets. Therefore the proposed configuration for this scenario is:

$$b = 256$$

$$h = 50$$

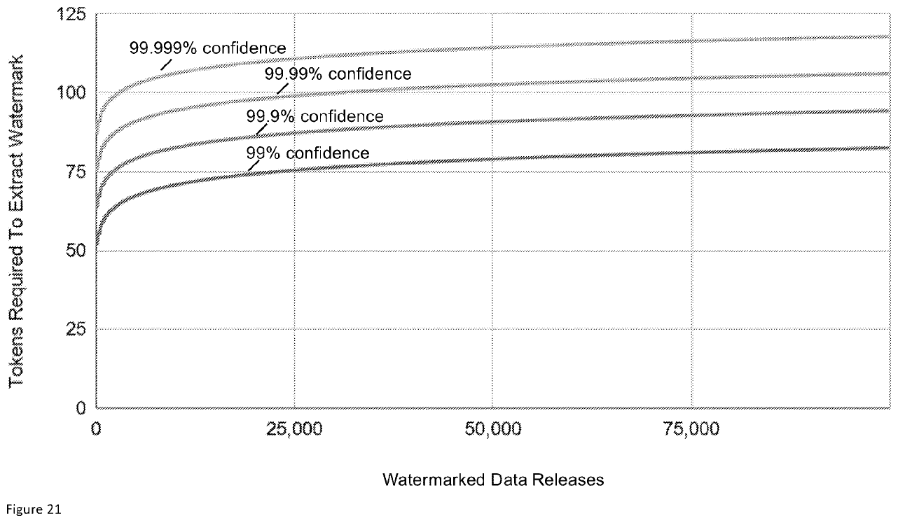

This gives a token rejection rate of about 17.8%. FIG. 21 shows a diagram illustrating extraction token count requirements as the number of data releases grows.

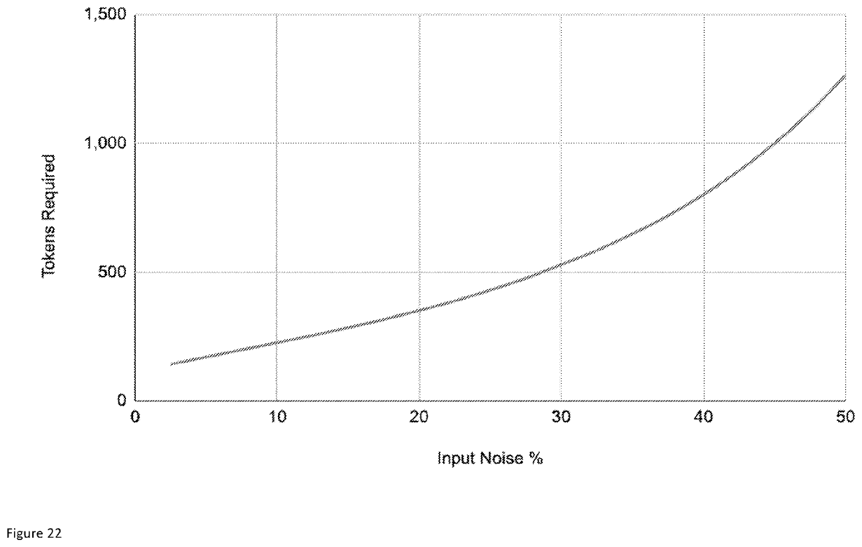

FIG. 22 shows a plot of the tokens required to extract the watermark at 99.9% confidence for the first Hash Array instance (supporting up to 256 data releases) as a function of the percentage of input noise.

### Scalability

### Computation Time

The largest component of the computational cost of the algorithm is in calculating the cryptographic hash. Therefore, it may seem that as h increases, the computational cost of the algorithm will increase significantly. However, thanks to the Kirsch-Mitzenmacher Optimisation it is only ever necessary to calculate a single 64 bit hash, and then multiple 32 bit hashes can be cheaply derived from this through a multiply-and-mod operation without any loss of randomness. Increasing the number of hashes does increase the amount of computation required, but in a reasonably modest way (from benchmarking, the cost of computing fifty hashes when embedding a watermark is ~1.7× the cost of computing one hash, not 50×).

This optimisation may not apply as we increase m, since each Hash Array instance has its own base key. Therefore, computation time does scale linearly with m. However, this is only of concern when we need to calculate hashes across different Hash Array instances when extracting a watermark. When embedding a watermark (which is the only operation on the tokenisation critical path), we only ever need to test a single Hash Array instance (the one containing the data release we are embedding the watermark for) and so embedding computation time is independent of m.

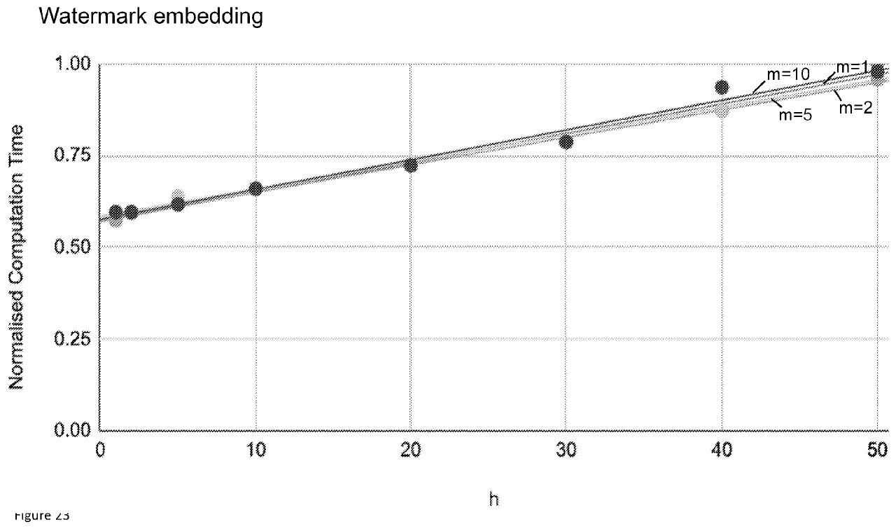

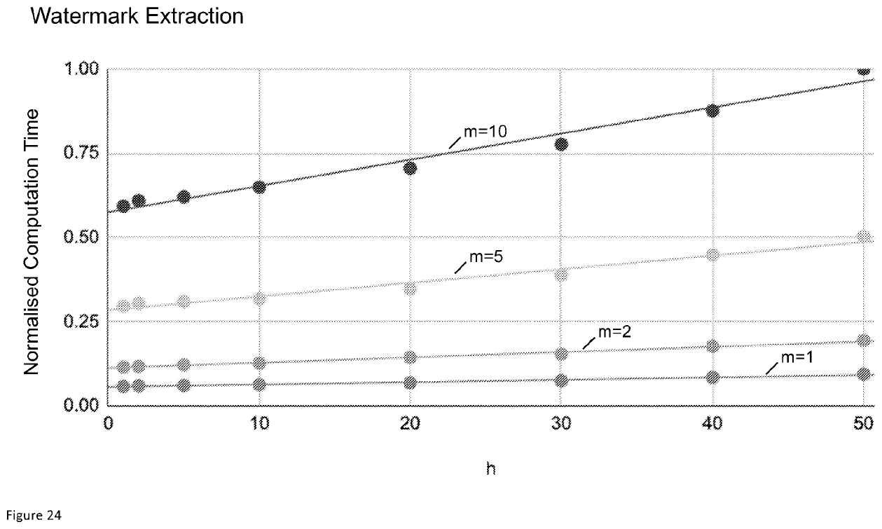

FIGS. 23 and 24 show the results of benchmarking runs that confirm these assertions. FIG. 23 plots the normalized computation time for watermark embedding, and FIG. 24 plots the normalized computation time for watermark extraction. Note that in each graph the vertical axis values have been normalised within the scope of that particular test, since the absolute values will vary depending on environment and the trend is all that we are interested in.

### Memory

Extracting a watermark requires the bins to be held in memory whilst the data is traversed, incrementing the bin counts (we also use a single Bloom filter—regardless of the values of h, b, and m—that requires a small amount of memory). Increasing h or m will result in more copies of the bin array being in memory and increasing b will result in the bin array being larger in each copy. The values of b and h are fixed for our scenarios, and far too small to use much memory per Hash Array instance. However, the memory needed to extract a watermark will grow as the number of watermarks that have been embedded grows (i.e. as m grows). Should m reach a large enough number that memory usage becomes a problem, it may be necessary to do multiple passes through the data, partitioning the values of m across them.

Embedding a watermark requires no state to be stored in memory and so is unaffected.

### Results

### Summary

This section presents the results of experiments run against the proposed scheme to validate various aspects of its behaviour. In summary, these results show us that:
Embedding an extractable watermark requires the expected number of tokens
The rate of false positive matches returned by the extraction is bounded by the confidence level, and so can be tuned to be arbitrarily low
Extraction is tolerant to random noise at the cost of requiring more rows in the noisy case, with the row requirement rising as modelled
A mix of multiple data release watermarks results in all of the individual watermarks being extracted, even with the additional presence of random noise.

Note: all the results presented in this section were obtained using a similar bulk dataset configuration (b=1024 and h=10). However, the observations also apply to datasets having any other configuration, just with the absolute numbers scaled in the way predicted in the previous discussion.

### Extraction Outcomes

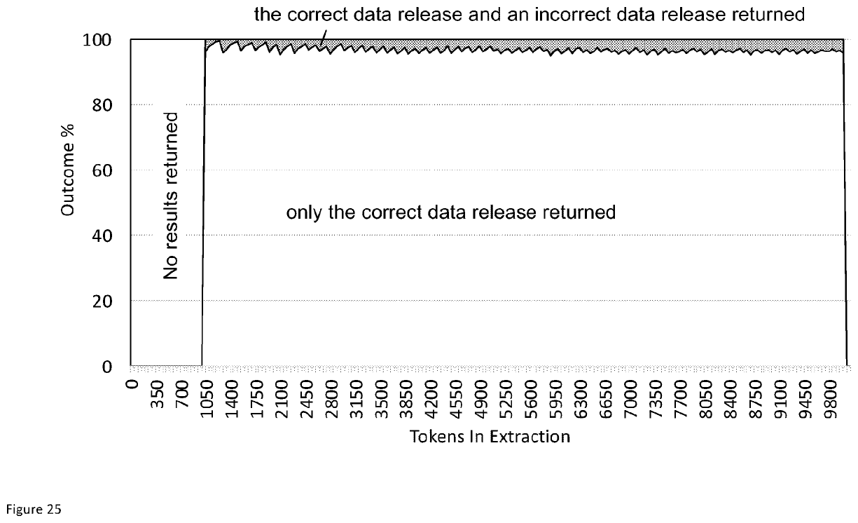

FIG. 25 shows the ultimate outcome of a watermark extraction performed with a confidence level of 95%, as the number of tokens processed in the extraction increases. Each data point is the average of 10,000 experiments and shows the split of outcomes across three mutually exclusive possibilities: no results returned; only the correct data release returned; the correct data release and an incorrect data release returned (note that there is a theoretical fourth outcome—only incorrect data releases returned—but this never occurred).

Here we clearly see the effect of the confidence level parameter, which is to bound the rate at which false positives are returned (once we hit the token count at which our modelling tells us that we will need to extract the watermark at 95% confidence—1017 tokens—we always get back the correct data release, but it is accompanied by a false positive result at a rate that never exceeds the alpha level implied by our confidence).

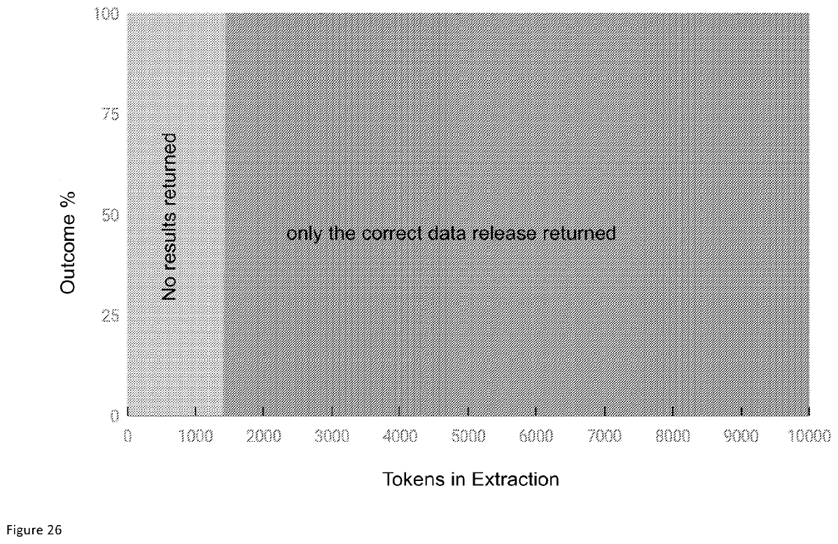

The previous graph demonstrates the use of a 95% confidence level so that the effect of this parameter can be easily visualised, but in a watermark extraction a false positive is an undesirable event—in some situations it may result in accusing an innocent recipient of being the source of a data leak—and so a false positive rate of 5% would be far too high for a real usage. But the confidence level gives us an easily understandable mechanism for reducing the frequency of false positives down to a desired level—if a user specifies a confidence level of 99.9% then they can be sure that a false positive will be returned in no more than 0.1% of cases. And since the score for a true positive data release increases so rapidly with the number of tokens, this additional accuracy comes at only a modest cost to the number of tokens required to extract the actual watermark. This is shown in FIG. 26, which repeats the experiment above but at a confidence level of 99.9%.

### Noise Tolerance

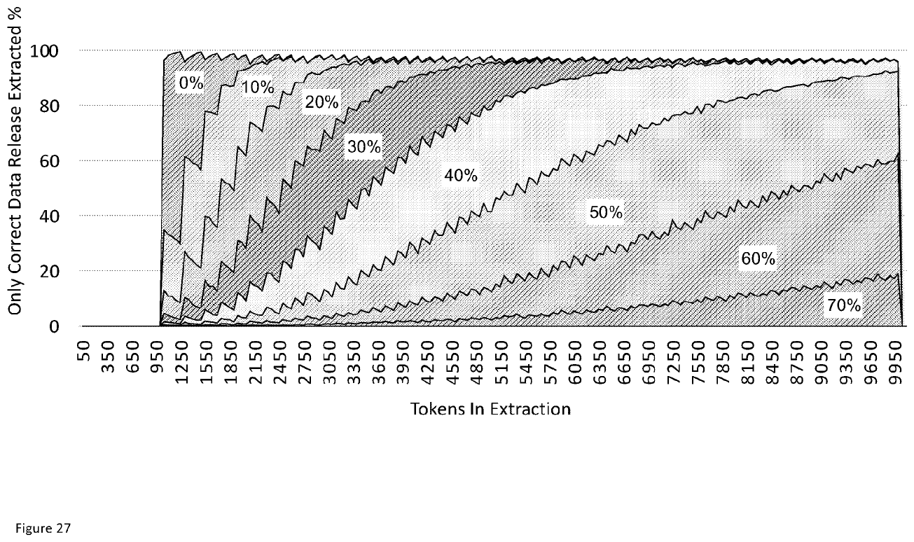

The experiment above was repeated, but with an increasing level of random noise progressively added. The graph in FIG. 27 shows how the percentage of times that we obtain only the correct watermarked data release varies with the noise level and the number of tokens that the extraction was performed over (again at a confidence level of 95%, to allow the effect to be clearly seen). The graph shows that, as expected, the number of tokens required to obtain the correct result at the specified confidence level grows.

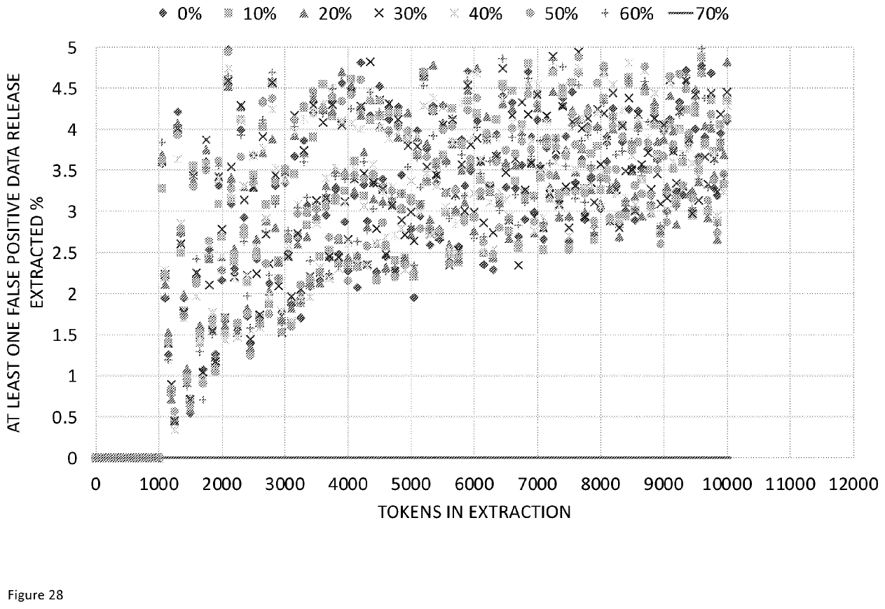

FIG. 28 shows the false positive occurrence percentage for the same experiments (here a false positive is recorded whenever at least one erroneous data release was returned, regardless of whether the correct data release was also returned).

Here we can clearly see that the false positive rate is bounded by the supplied confidence level (and that it does not depend on the level of noise).

### Number of Tokens Required to Achieve Confidence

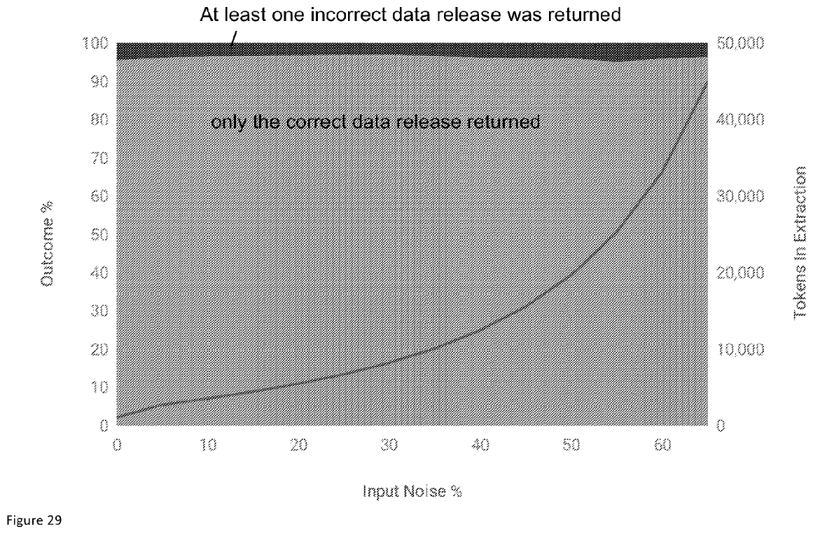

The earlier discussion of the watermark extraction algorithm presents a method for estimating the number of tokens that are needed to extract the watermark for a given confidence level and amount of noise added to the input dataset. To test the accuracy of this, the number of tokens required to extract the watermark at 95% confidence were calculated for various noise levels and then an experiment was run for each of these where we attempt to extract the watermark over a dataset of this size 10,000 times and record the outcomes. The results of this experiment are shown in FIG. 29 (the area representing the percentage of time where only the correct data release was returned and the area representing the percentage of times at least one incorrect data release was returned, regardless of whether the correct data release was also returned, and the line—which uses the right hand y-axis—shows the number of rows that the extraction for that noise level was performed over).

From this graph we can see that the estimate for the number of tokens required is accurate—we see that the rate of successful extractions tracks the expected confidence level well (and, as usual, the false positive rate never exceeds the expected 5%).

### Mixed Data Release Watermarks

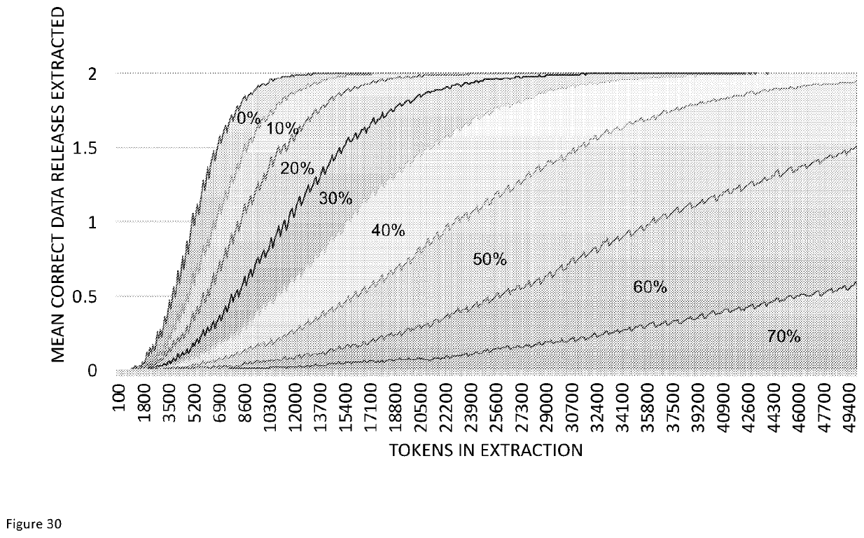

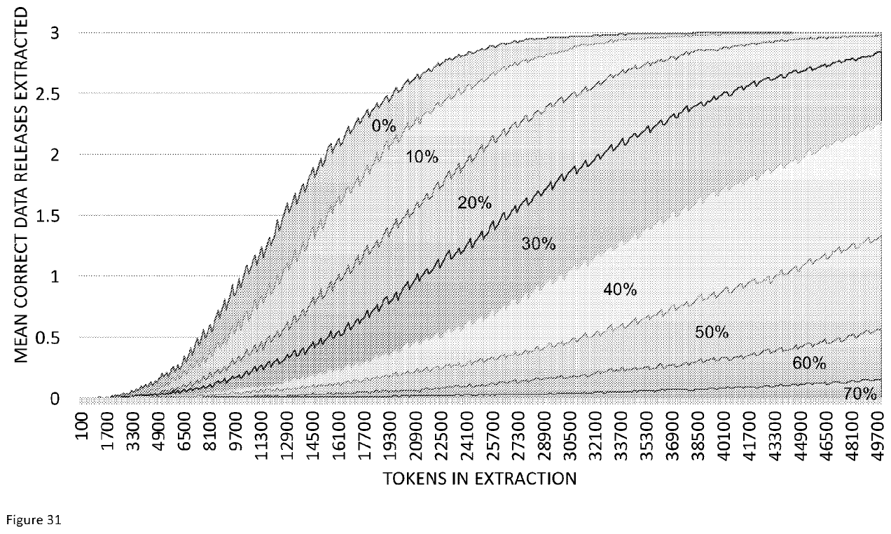

FIGS. 30 and 31 show the results of an experiment where the input to the extraction function was a data set containing multiple data release watermarks mixed together, with the addition of progressively higher levels of random noise. FIG. 30 shows an experiment where 2 data release watermarks were mixed together, and FIG. 31 shows a mix of 3 data release watermarks. In all instances the watermarks were shared equally across the tokens remaining after the random noise was added (for example, the 40% noise results comprise 40% noise/30% data release1/30% data release2 in FIG. 30 and 40% noise/20% data release1/20% data release2/20% data release3 in FIG. 31). All experiments were run at a confidence level of 95%.

Here we can see that the multiple watermarks are correctly disentangled, even with the addition of random noise. As expected, more tokens are required to extract more watermarks (since from the point of view of one of the watermark bins, the data carrying the other watermark just appears as random noise and so slows down the extraction of that watermark in the way shown in the previous sections).

The false positive rate is not shown in the graphs above but is bounded at 5% as expected.

### Alternative Data Release Representation

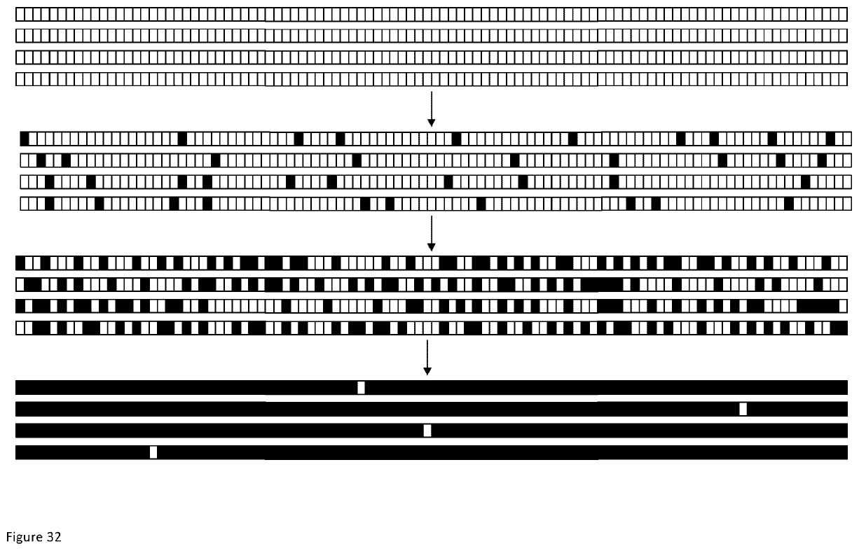

Our proposed scheme uses the same bin for a data release in each Hash Array. But an alternative scheme would use a different bin in each hash function for the data release, representing the data release as a set of hash function+bin pairs (one for each hash function)—a bin in any given hash function will be used for multiple data releases, but the combination of bins across hash functions will be unique to that data release. As shown in FIG. 32, this configuration gives us many more data releases than for the previous case, though since the hash functions are no longer working together so directly more tokens are required to extract the watermark (in our original configuration, a token hash appearing in a bin for any of the hash functions was enough to rule that bin out of consideration in all hash functions; with this alternative scheme this is no longer the case and each hash function works independently). However, this will still require fewer tokens than a single hash function construct—each token added eliminates a bin in each of the hash functions, and the sum of all of the values across all of the hash functions for a data release's bins allows us to reach a higher confidence score with fewer tokens.

With this configuration the number of watermarks that are supported is given by:

$$N = m \times {b}^{h}$$

But this exponential growth in data releases was ultimately the reason that this configuration was rejected. As we have seen, there is a fundamental relationship between the number of tokens required to extract the watermark and the number of data releases that can be supported for a given token rejection rate—therefore, somewhat paradoxically, it is actually advantageous to have a scheme where the growth in the number of data releases is slower so that we can more exactly fit the token rejection rate as close as possible to the allowed 1% bound, thus getting as close as possible to the minimum number of required tokens.

### Appendix A—Watermarking Deterministic Tokenisation

This appendix summarises the key features A-D. Each feature listed can be combined with any other feature A-D. Each optional feature defined below can be combined with any feature and any other optional feature.

### Key Feature A: Process of Incorporating Digital Watermarking on Top of Deterministic Tokenization.

Computer implemented process for embedding a digital watermark within tokenised data, comprising the steps of:
(a) generating tokens from a set of input data, in which tokens are generated using a deterministic encryption scheme; and
(b) embedding the digital watermark within the set of generated tokens.
   Key Feature B: Process of Incorporating Digital Watermarking on Top of Deterministic Tokenization, in which the Digital Watermark is Probabilistically Embedded Through the Choice of Tokens in the Set of Generated Tokens.

Computer implemented process for embedding a digital watermark within tokenised data, comprising the steps of:
(a) generating tokens from a set of input data, in which tokens are generated using a deterministic encryption scheme; and
(b) embedding the digital watermark within the set of generated tokens; and in which the digital watermark includes a pattern that is probabilistically embedded through the choice of tokens within the set of generated tokens.
   Key Feature C: Process of Incorporating Digital Watermarking on Top of Deterministic Tokenization, in which the Digital Watermark can be Reconstructed without Prior Knowledge of the Encryption Scheme or any Other Processing Used on the Set of Input Data.

Computer implemented process for embedding a digital watermark within tokenised data, comprising the steps of:
(a) generating tokens from a set of input data, in which tokens are generated using a deterministic encryption scheme; and
(b) embedding the digital watermark within the set of generated tokens; and in which the digital watermark can be reconstructed without prior knowledge of the encryption scheme or any other processing used on the set of input data.
   Key Feature D: Process of Incorporating Digital Watermarking on Top of Deterministic Tokenization, in which the Number of Possible Watermarked Data Releases can be Dynamically Scaled.

Computer implemented process for embedding a digital watermark within tokenised data, comprising the steps of:
(a) generating tokens from a set of input data, in which tokens are generated using a deterministic encryption scheme;
(b) embedding the digital watermark within the set of generated tokens; and
(a) generating a data release, and in which the digital watermark is chosen or selected based on the parameters of the data release;
   and in which the number of possible watermarked data releases can be dynamically scaled.

### Optional Features

### Process of Embedding the Digital Watermark

The digital watermark is embedded in the set of generated tokens and not in any metadata or redundant data.
The deterministic encryption scheme is a pseudorandom permutation scheme, such as a pseudorandom permutation scheme based on a format preserving encryption cipher.
The process includes the steps of:
(a) scanning or observing an input space that corresponds to the set of input data,
(b) determining or identifying the inputs that should be mapped to watermark tokens.
inputs that should be mapped to watermark tokens are inferred from a knowledge of the input space and what the input space represents.
The inputs that should be mapped to watermark tokens are the inputs that are less likely to appear or be encountered (less likely to appear refers to exploiting distributions in the probability of encountering the possible input values such that the tokens we do not wish to return are mapped to those inputs that we do not expect to encounter).
The process includes the step of dividing the input space into two separate or disjoint subspace, a ‘non-watermark input subspace’ and a ‘watermark input subspace’, in which the inputs of the non-watermark input subspace are mapped to non-watermark tokens, and the inputs of the watermark input subspace are mapped to watermark tokens.
The encryption of each input subspace is achieved independently.
The algorithm includes two deterministic encryptions schemes such as FPEs (Format Preserving Encryption).
An FPE is configured to encrypt the non-watermark input subspace, and the other FPE is configured to encrypt the watermark input subspace.
The two deterministic encryption schemes are each based on a secret key.
Digital watermark pattern is embedded within watermark tokens, in which the watermark tokens are assigned or determined such that their tokens hash to a value that falls within a predefined range of a hash space.
Hashing of the tokens is done using a cryptographic hash function based on a secret watermarking key, so an attacker cannot learn within which subspace a token resides.
The process includes the step of endeavouring to map the watermark tokens such that they will never or rarely be returned, such that a bin of the hash space contains no value or near zero value.
Watermark tokens are assigned or determined dynamically at run time to avoid having to brute force search the entire token space.
Determining the watermark tokens includes the step of
   (i) segmenting the token space into segments, and
   (j) assigning a watermark token per segment.
The watermark token is assigned by scanning a segment to find the first token within the segment that hashes to a value within the predefined range.
The starting index for scanning each segment is chosen using a pseudorandom number generator (PRNG) seeded with the segment index.
If we reach the starting index without finding a watermark token, then the final index of the segment is chosen as the watermark token.
The size of the segments is chosen so as to give a high probability that each segment will contain no more than one token that hashes to the watermark range (assuming uniform distribution from the hash function) to avoid having to return these tokens for inputs other than those intended.
   Reconstruction or Extraction of the Digital Watermark from a Data Release
The digital watermark can be reconstructed without prior knowledge of the deterministic encryption scheme(s) or any other scheme used on the set of input data.
Digital watermark is reconstructed by (a) hashing the tokens in the data release using one or more hash functions, (b) building up a histogram of hash frequency of the hash space, and (c) determining the bin that corresponds to the digital watermark.
When multiple hash functions have been used, the process includes the step of summing the number of hashes for each bin across all of the hash functions.
Each hash function includes a different key.
The process includes the step of calculating a probability of getting an observed number of hashes, or fewer, in a specific bin when the watermarked data release does not include the digital watermark that corresponds to the specific bin
When the calculated probability is lower than a predefined threshold, the process infers that the data release contains a particular digital watermark.
The process allows for the reconstruction of the digital watermark on only a subset of a data release.
The process is able to handle noise, such as the addition or removal of rows of the data release.
The extraction of the digital watermark is associated with a confidence score that relates to the likelihood (a) of the presence of a watermark in the tokenised data and (b) that an underrepresented bin within the histogram of token hash counts corresponds to the hash bin. (how sure we can be that the watermark is really present in the tokenised data and that an underrepresented bin within the histogram of token hash counts isn't just an artefact of random chance.)
The process includes the step of estimating the number of tokens needed to reconstruct a digital watermark.
The number of tokens is estimated for a given confidence level and amount of noise present in the tokenised data.

### Digital Watermark is Dependent on the Parameters of the Data Release

The computer implemented process includes the step of generating a data release, and in which the digital watermark is chosen or selected based on the parameters of the data release.
The digital watermark is chosen or selected based on the data release recipient(s).
The digital watermark is chosen or selected based on the data release intended use.
The digital watermark is chosen or selected based on a date by which the data release must be deleted.
Each data release corresponding to the same set of input data that has been tokenised includes a different digital watermark.
The digital watermark represents a pattern that is a unique ID.
The digital watermark is chosen or selected based on the type of input data that has been tokenised (i.e ID, social security number, high, salary etc).
The digital watermark is chosen or selected based on the deterministic encryption scheme used.
The process includes the step of dynamically scaling the number of possible watermarked data releases by updating the hash function.
The process includes the step of dynamically scaling the number of possible watermarked data releases by hashing the token space with another hash function.

### Computer Device or System

A computing device or system adapted to embed a digital watermark within tokenised data, the device or system comprising a processor that is configured to:
(c) generate tokens from a set of input data, in which tokens are generated using a deterministic encryption scheme; and
(d) embed the digital watermark within the set of generated tokens.

### Appendix B—Handling Variable Length Inputs in Deterministic Tokenisation

### Deterministic Tokenisation Background

In deterministic tokenisation, a format preserving encryption cipher is used to provide a permutation between all of the values within some space to another value within the same space. For example, the space may be declared as the entire set of valid credit card numbers—the deterministic tokenisation system would then accept as input a credit card number and return as output another credit card number, to use as a token in place of the real value. The space of values/tokens is defined using a regular expression.

### How it Works: a Simple Example

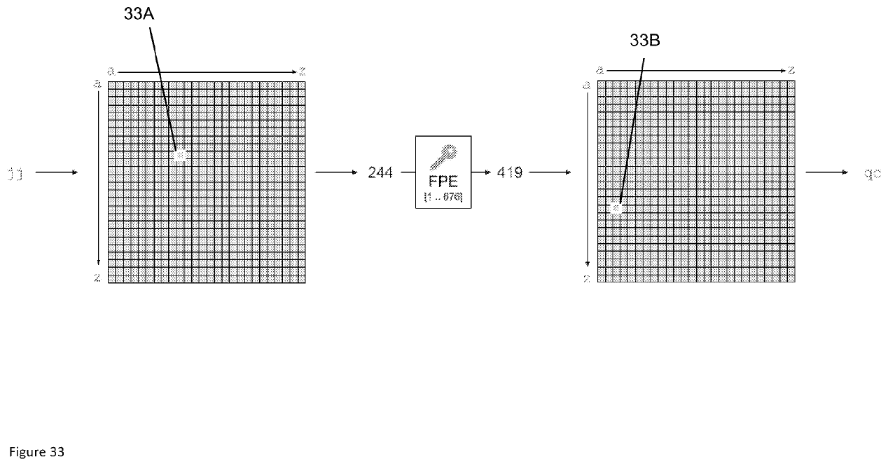

An example is depicted in the diagram shown in FIG. 33, in which the full input and token spaces have been rendered using a small square for each possible value—these have been arranged into a larger square to fit with the two dimensional nature of the example expression (and for space reasons), but they could also have been shown as a long list of values.

As an example, let's assume that the values that need to be tokenised all comprise two lowercase alphabetic characters. The regular expression [a-z]{2} is used to define this space. Every value that matches this expression can be assigned an ordinal in the range [1 . . . 676]. Imagine that we need to tokenise the input jj—this is the logic that the deterministic tokenisation system performs:
1. Find the ordinal of the input value within the regular expression. In our example the input is jj—for simplicity's sake we assume that the ordering is lexicographical (but in reality it need not be) and hence the input ordinal is (9*26)+10=244 (the input ordinal 33A is shown in FIG. 33).
2. Encrypt this ordinal using the format preserving encryption cipher. For the sake of our example, let's imagine that this gives an output of 419
3. Determine the value from the regular expression with ordinal 419. In our lexicographical ordering, this gives a first character of (419/26)+1=17 (so q) and a second character of 419 mod 26=3 (so c).
4. Therefore input jj is tokenised to token qc (the token qc 33B is shown in FIG. 33).
   The Problem with Using Deterministic Tokenisation on Variable Length Values

The deterministic tokenisation system works well for values that have a fixed structure—for example credit card numbers, social security numbers, zip codes. But it works less well for data that is more freeform and can have variable lengths—for example names, addresses, email addresses. Since a regular expression can be written that accepts some character a variable number of times, it is possible to make it function on variable length data, but the results may not be satisfactory to the user.

Consider a fairly simple scenario: tokenising surnames. The US Census website provides a list of the most common surnames from the 1990 survey—this covers over 90% of the population, and so we can base our discussion on that (in the real world we would need to worry about outliers such as double-barrelled surnames, but we ignore that for now).

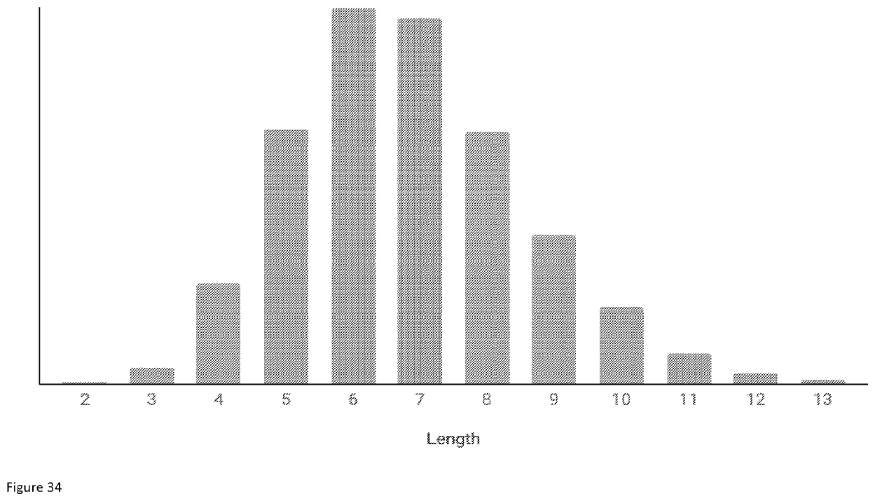

From this list, we can see that the surnames range in length from 2 to 13 characters, and have the distribution shown in FIG. 34.

So we might craft the expression [A-Z][a-z]{1,12} to entirely cover the input range. This will work, but what will the resultant tokens look like?

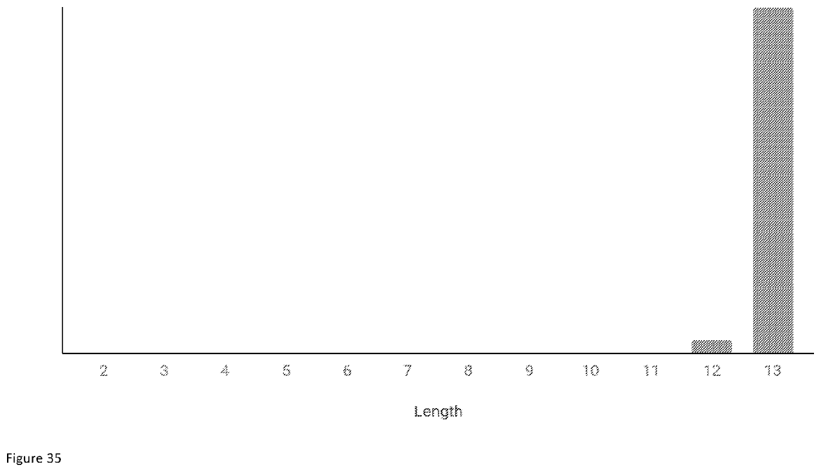

Because the tokenisation uses a strong encryption cipher, the choice of tokens from within the token space will be indistinguishable from random—every possible token will be as likely as every other to be the output for a value. This means that the distribution of lengths in a random sample of tokens will have the same distribution as the lengths of all possible tokens. There are 676 possible 2 character tokens, 17576 possible 3 character tokens, etc—by the time we get to a length of 13 characters, there are over two quintillion possible tokens. The distribution of tokens is shown in FIG. 35 with a chart plotted with linear scale axes.

Adding an additional character results in 26× the number of possible tokens as for the previous token length, so the number of tokens with each length grows exponentially. For the real data, the most common surname length was 6 characters—however, over 96% of the generated tokens will have a length of the maximum 13 characters and the chance of getting a 6 character token is about 1 in 84 million.

Perhaps in the above toy example, this is not a serious problem—the tokens are intended to be a meaningless replacement for the raw values and we wouldn't expect to be able to use them to do any analysis of name lengths. But what happens when we make the example more realistic—when we attempt to expand the expression to cover double-barrelled surnames? Every time we add a character to the expression, we are also extending the length of the vast majority of tokens that we will encounter. What about if we want to handle data such as email addresses? To be sure of covering every possible email address, we need to allow 64 characters for the local portion and 255 characters for the domain portion, giving (effectively) all of our tokens a length of 320 characters—this is quite some explosion in data size and will not be acceptable.

The current state of the art in format preserving masking systems avoid this problem by treating each different input value length as its own encryption cipher and generating tokens that match the length of the input (so in our names example, if it received a 6 character name it would tokenise it using the expression [A-Z][a-z]{5} and produce a 6 character token). However, we consider that this is an unacceptable privacy risk since it offers no privacy at all for values with unique lengths. To illustrate this, we used a specific company employee list as given on a specific date 06/04/2021—of the 158 employees on that day, 26 (a very significant 16%) are uniquely identifiable using only the lengths of their first name and surname, and a length preserving scheme would offer no protection at all for these people.

### Proposed Solution

We wish to achieve a system where the distribution of token lengths resembles the distribution of input lengths, but where the length of a token is not directly linked to the length of its input. There is a clear tension between these two requirements, but it is sufficient to break the direct deterministic link between value and token length and instead adopt a scheme where a 6 character value is more likely to have a 6 character token, but there is still an appreciable (and controllable) chance that it will not. Then if we tokenise a data set with a single lengthy value in it, if we see a lengthy token it is not guaranteed that this is the lengthy input (there is an element of plausible deniability).

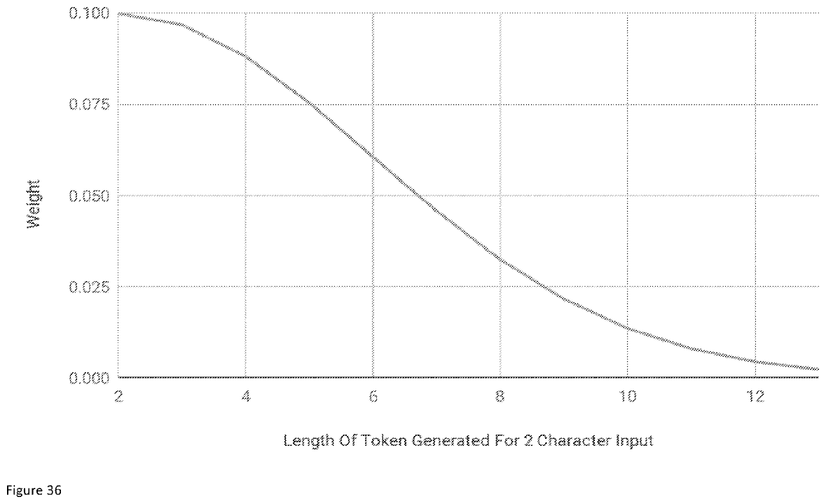

Our proposed solution works by treating each length as a separate format preserving encryption, but allocating ranges of the ciphertext to tokens of different lengths. It is configured with the minimum and maximum lengths, and for each input length it generates a distribution (e.g. a normal distribution) centered on that length with some standard deviation (which may be surfaced to the user as some “spread” parameter), and uses this to derive a weighting for how many of the tokens of the input length are allocated to tokens of that length. Use as an example [a-z]{2,13}. FIG. 36 shows a graph of the weights that control how many tokens of each length are generated for the first input value length, 2, using a standard deviation of ⅓ of the range.

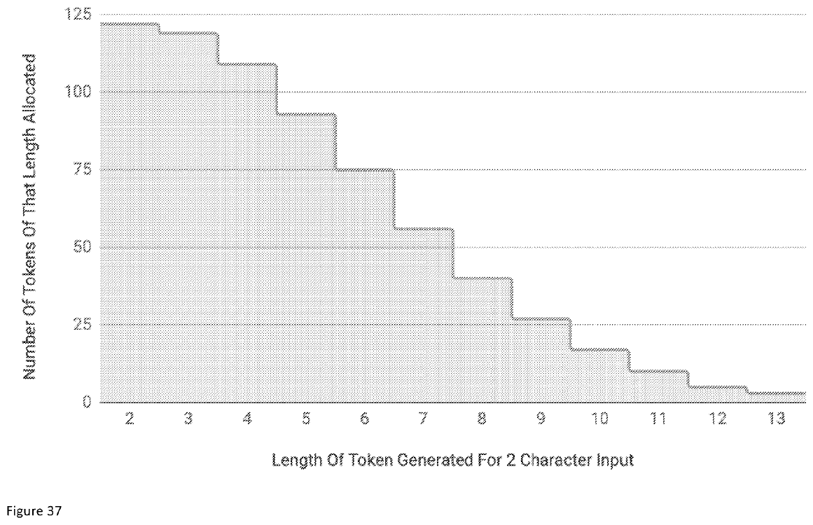

We then normalise these weights, and multiply each by the total number of tokens that we have to allocate (in this case we are working out allocations for 2 character strings, so there are 676 of these) to work out how many of these are allocated to tokens of each length. The graph of the length token generated as a function of the number of tokens of that length allocated is shown in FIG. 37 for the 2 character input.

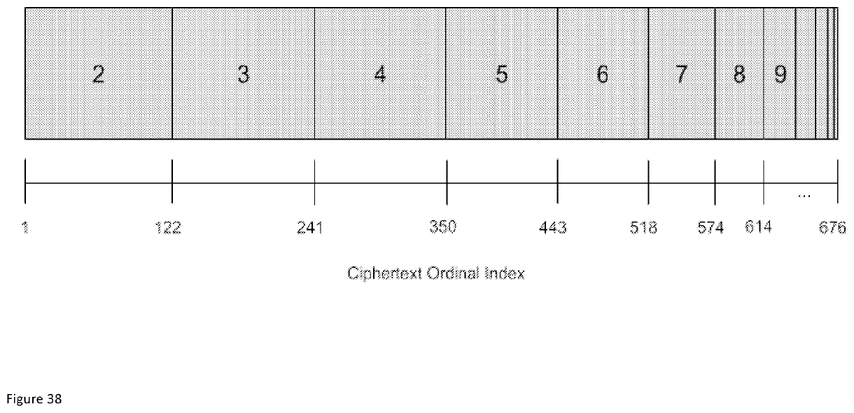

So of the 676 possible 2 character input strings, we allocate 122 of them to 2 character tokens, 119 to 3 character tokens, etc, with only 3 of the inputs being mapped to 13 character tokens. When we get a 2 character input, we do a format preserving encryption to map its ordinal within the 1 . . . 676 input space to a ciphertext ordinal in the same space. We then interpret this ciphertext ordinal differently depending on which region of the ciphertext space it falls within. This is illustrated in the diagram of FIG. 38.

For example, if we get a 2 character input whose 1 . . . 676 ordinal within the space of all 2 character inputs encrypts to ordinal 360, then we will return a 5 character token for this input.

We then move on to the next input length—in our example, 3—and repeat the process.

Once these weights and ranges are initialised, the cipher can be used to tokenise. In our example above, our 2 character input is encrypted to ordinal 360 so we will return a 5 character token for it. But which 5 character token? We start indexing into the space of 5 character tokens first using the chunk that was contributed by 2 character inputs, then the chunk for 3 character inputs, etc. So in our example, ordinal 360 is 10 ordinals from the start of the chunk for 2 character inputs, so we get ordinal 10. But doing this means that the first N ordinals of any token length are always assigned to 2 character inputs, then the next M ordinals to 3 character inputs, etc, leading to a bias where the tokens with the lower ordinals are assigned to shorter inputs. To correct this, having obtained the ordinal within the 5 character space we then do a further FPE just within that space, which randomises all of mappings to tokens of that length again so there is no systematic bias introduced.

### Watermarking

Watermarking still works as described in the description above relating to a process for embedding a digital watermark in tokenised data. The watermark inputs are selected from the longest input length (since we assume this is one of the least likely to occur in actual data) and then these inputs are assigned to the watermark tokens across all of the lengths. The watermark tokens in each length are found as described in detail above—we assume each length contains

$$\frac{num tokens for that length}{num watermark bins}$$

watermark tokens, which are found dynamically using the previously described segmenting and dynamic scanning technique.

The proposed solution may therefore be combined with any one or more of the features or any one or more of the optional features from Appendix A, in which the generation of tokens is described above.

### Appendix C—Handling Variable Length Inputs—Summary of Key Features

This appendix summarises the key features E-F. Each optional feature defined below can be combined with any feature and any other optional feature.

Key Feature E—Generating Tokens from a Set of Input Data of Varying Length

A computer implemented process for generating tokens from a set of input data that includes input values of varying length, in which the process includes the step of generating tokens from the set of input data, the tokens having lengths that exhibit a substantially similar distribution as the distribution of lengths of the set of input data.

### Optional Features:

The length of a token is not necessarily matched to the length of its corresponding input value.
Tokens are generated using an encryption scheme that treats each subset of the input data corresponding to a specific length of input values as a separate or distinct format preserving encryption.
For each subset of the input data corresponding to a specific length of input values, tokens are generated with varying lengths.
For each subset of the input data corresponding to a specific length of input values, tokens are generated with varying lengths, in which the generated tokens have lengths that conform to a chosen distribution generated for that specific input length.
Once tokens are generated from the subset of the input data corresponding to that specific length of input values, an additional format preserving encryption is used on the generated tokens.
Tokens are generated based on one or more potentially user-configurable parameters, including a minimum token length, a maximum token length or the distribution to use to assign token length weightings.
   Key Feature F—Embedding a Digital Watermark within the Tokens Generated from a Set of Input Data of Varying Length

A computer implemented process for embedding a digital watermark within tokenised data, the process comprising the steps of:
(a) generating tokens from a set of input data that includes input values of varying length, in which tokens are generated with lengths that exhibit a substantially similar distribution as the distribution of lengths of the set of input data, and
(b) embedding the digital watermark within the set of generated tokens.

### Optional Features:

### Token Generation

The length of a token is not necessarily matched to the length of its corresponding input value.
Tokens are generated using an encryption scheme that treats each subset of the input data corresponding to a specific length of input values as a separate or distinct format preserving encryption.
For each subset of the input data corresponding to a specific length of input values, tokens are generated with varying lengths.
For each subset of the input data corresponding to a specific length of input values, tokens are generated with varying lengths, in which the generated tokens have lengths that conform to a chosen distribution generated for that specific input length.
Once tokens are generated from the subset of the input data corresponding to that specific length of input values, an additional format preserving encryption is used on the generated tokens.
Tokens are generated based on one or more potentially user-configurable parameters, including a minimum token length, a maximum token length or the distribution to use to assign token length weightings.

### Process of Embedding the Digital Watermark

The digital watermark includes a pattern that is probabilistically embedded through the choice of tokens within the set of generated tokens.
The digital watermark can be reconstructed without prior knowledge of the encryption scheme or any other processing used on the set of input data.
The process includes the step of generating a data release, and in which the digital watermark is chosen or selected based on the parameters of the data release; and in which the number of possible watermarked data releases can be dynamically scaled.
The digital watermark is embedded in the set of generated tokens and not in any metadata or redundant data.
The process includes the steps of.
   (a) scanning or observing an input space that corresponds to the set of input data,
   (b) determining or identifying the inputs that should be mapped to watermark tokens.
The inputs that should be mapped to watermark tokens are inferred from a knowledge of the input space and what the input space represents.
The inputs that should be mapped to watermark tokens are the inputs that are less likely to appear or be encountered (less likely to appear refers to exploiting distributions in the probability of encountering the possible input values such that the tokens we do not wish to return are mapped to those inputs that we do not expect to encounter).
The process includes the step of dividing the input space into two separate or disjoint subspace, a ‘non-watermark input subspace’ and a ‘watermark input subspace’, in which the inputs of the non-watermark input subspace are mapped to non-watermark tokens, and the inputs of the watermark input subspace are mapped to watermark tokens.
The encryption of each input subspace is achieved independently.
Digital watermark pattern is embedded within watermark tokens, in which the watermark tokens are assigned or determined such that their tokens hash to a value that falls within a predefined range of a hash space.
Hashing of the tokens is done using a cryptographic hash function based on a secret watermarking key, so an attacker cannot learn within which subspace a token resides.
The process includes the step of endeavouring to map the watermark tokens such that they will never or rarely be returned, such that a bin of the hash space contains no value or near zero value.
Watermark tokens are assigned or determined dynamically at run time to avoid having to brute force search the entire token space.
Determining the watermark tokens includes the step of.
   (k) segmenting the token space into segments, and
   (l) assigning a watermark token per segment.
The watermark token is assigned by scanning a segment to find the first token within the segment that hashes to a value within the predefined range.
The starting index for scanning each segment is chosen using a pseudorandom number generator (PRNG) seeded with the segment index.
If we reach the starting index without finding a watermark token, then the final index of the segment is chosen as the watermark token.
The size of the segments is chosen so as to give a high probability that each segment will contain no more than one token that hashes to the watermark range (assuming uniform distribution from the hash function) to avoid having to return these tokens for inputs other than those intended.
   Reconstruction or Extraction of the Digital Watermark from a Data Release
The digital watermark can be reconstructed without prior knowledge of the encryption scheme(s) or any other scheme used on the set of input data.
Digital watermark is reconstructed by (a) hashing the tokens in the data release using one or more hash functions, (b) building up a histogram of hash frequency of the hash space, and (c) determining the bin that corresponds to the digital watermark.
When multiple hash functions have been used, the process includes the step of summing the number of hashes for each bin across all of the hash functions.
Each hash function includes a different key.
The process includes the step of calculating a probability of getting an observed number of hashes, or fewer, in a specific bin when the watermarked data release does not include the digital watermark that corresponds to the specific bin
When the calculated probability is lower than a predefined threshold, the process infers that the data release contains a particular digital watermark.
The process allows for the reconstruction of the digital watermark on only a subset of a data release.
The process is able to handle noise, such as the addition or removal of rows of the data release.
The extraction of the digital watermark is associated with a confidence score that relates to the likelihood (a) of the presence of a watermark in the tokenised data and (b) that an underrepresented bin within the histogram of token hash counts corresponds to the hash bin. (how sure we can be that the watermark is really present in the tokenised data and that an underrepresented bin within the histogram of token hash counts isn't just an artefact of random chance.)
The process includes the step of estimating the number of tokens needed to reconstruct a digital watermark.
The number of tokens is estimated for a given confidence level and amount of noise present in the tokenised data.

### Digital Watermark is Dependent on the Parameters of the Data Release

The computer implemented process includes the step of generating a data release, and in which the digital watermark is chosen or selected based on the parameters of the data release.
The digital watermark is chosen or selected based on the data release recipient(s).
The digital watermark is chosen or selected based on the data release intended use.
The digital watermark is chosen or selected based on a date by which the data release must be deleted.
Each data release corresponding to the same set of input data that has been tokenised includes a different digital watermark.
The digital watermark represents a pattern that is a unique ID.
The digital watermark is chosen or selected based on the type of input data that has been tokenised (i.e ID, social security number, high, salary etc).
The digital watermark is chosen or selected based on the encryption scheme used.
The process includes the step of dynamically scaling the number of possible watermarked data releases by updating the hash function.
The process includes the step of dynamically scaling the number of possible watermarked data releases by hashing the token space with another hash function.

### Computer Device or System

A computing device or system adapted to generate tokens from a set of input data that includes input values of varying length, the device or system comprising a processor that is configured to generate tokens from the set of input data, the tokens having lengths that exhibit a substantially similar distribution as the distribution of lengths of the set of input data.

A computing device or system adapted to embed a digital watermark within tokenised data, the device or system comprising a processor that is configured to:
(e) generate tokens from a set of input data, in which tokens are generated with lengths that exhibit a substantially similar distribution as the distribution of lengths of the set of input data; and
(f) embed the digital watermark within the set of generated tokens.

### Appendix D—Embedding a Digital Watermark within Outputs from Generative AI, Such as Text Produced by an LLM (Large Language Model)

Since the described watermarking scheme is based on the rejection of outputs that hash to within the watermark bin, any process can embed a watermark as long as it meets the following two criteria:
1. There must exist the possibility to substitute one potential output for another, so that if the initial choice of output is a watermark token then a different, non-watermark token, output may be chosen instead.
2. There must be some system for interpreting the potential outputs as ‘tokens’ that can be hashed, to determine whether they are watermark tokens. For text generation this is obvious, but there are many ways of interpreting binary outputs in the same manner—for example using the pixel values within an image or video frame, or the frequency of sound samples, since it is possible to make minor modifications to these without affecting the output in a significant way. Where the term ‘token’ is used within this text, it should be understood to refer to the potential output of any generative system that is interpreted in this manner, and not simply text.

Generative AI systems that produce text, images, video or audio meet both criteria and therefore the scheme may be used to watermark their outputs. To see exactly how this would work, let us take text generated by an LLM as an example. An LLM generates text by outputting a sequence of generated tokens, where the tokens may be for example words, parts of words or punctuation. Each token is generated using a probability distribution of the most suitable next token to produce in response to the prompt, taking into account the previous tokens that have been generated. But the system does not always simply select the token with the highest probability—it has an element of randomness where it may select a token with a lower probability. This is where the watermarking scheme can be inserted. If the system hashes the token that it is about to return, it can determine whether the token is a watermark token. If it is, it can reject that token and resample from the distribution to select a different token, and repeat until it selects a non-watermark token that it can then return (in the unlikely event that no non-watermark token is available for selection, the watermark token would have to be returned, but this would merely add a small amount of noise to the resultant watermark as discussed in the “Handling Noise” section on page 25).

The presence of the watermark can be used to determine that the content was produced by the Generative AI system. But each watermark can also be unique to the prompting user, so that extraction of the watermark would reveal not just that the content was produced by a Generative AI, but also the user for which it was generated. Moreover any metadata about the user, the time of use and the context for which they are generating content can be associated with the watermark.

Hence, using the watermarking scheme described, the Generative AI output may be watermarked using either one or a combination of the following:
1. Global—a single watermark for all generative AI output. This may be for example to verify that the output was machine generated or not.
2. User scoped—every output generated for the same user has the same watermark, and different users get different watermarks. The watermark tells you that it was machine generated and for which user.
3. Prompt scoped—every user and/or prompt combination gets its own watermark, so you can tell not just which user but which of their prompts. Optionally, a timestamp may also be used to disambiguate the same prompt.

Advantageously, associating the digital watermark to either a specific user or specific prompt or a combination of both enable the tracking of how generated content is being used, thereby adding an extra layer of security or customisation.

This is made possible because the system is scalable so that individually watermarking of any number of generative AI outputs is possible.

Advantageously, the detection or extraction of the digital watermark can be achieved from any sampled subset of tokens, whether the sampled subset of tokens is taken contiguously or randomly.

This is possible because the process implemented is such that whether a particular token is a watermark token or not is only a function of the token, the watermark being embedded, and a watermarking key. Hence whether a particular token is a watermark token or not does not depend on the previously generated token or tokens.

We now list a number of key features A1-D1. Each feature listed below can be combined with any other feature A1-D1. Each optional feature defined below can be combined with any feature and any other optional feature.

Key Feature A1: Process of Incorporating Digital Watermarking into a ‘Generative-AI Output’ or Generated Content

Computer implemented process for embedding a digital watermark within generated content, comprising the steps of
(a) generating tokens from input data such as a user prompt using a Generative AI such as an LLM; and
(b) embedding the digital watermark within the set of generated tokens.
   Key Feature B1: Process of Incorporating Digital Watermarking into Generated Content, in which the Digital Watermark is Probabilistically Embedded Through the Choice of Tokens in the Set of Generated Tokens.

Computer implemented process for embedding a digital watermark within generated content, comprising the steps of
(a) generating tokens from input data such as a user prompt using a Generative AI such as an LLM; and
(b) embedding the digital watermark within the set of generated tokens;
   and in which the digital watermark includes a pattern that is probabilistically embedded through the choice of tokens within the set of generated tokens.
   Key Feature C1: Process of Incorporating Digital Watermarking into Generated Content, in which the Digital Watermark can be Reconstructed without Prior Knowledge of the Generation Process or any Other Processing Used.

Computer implemented process for embedding a digital watermark within generated content, comprising the steps of
(a) generating tokens from input data such as a user prompt using a Generative AI such as an LLM; and
(b) embedding the digital watermark within the set of generated tokens; and in which the digital watermark can be reconstructed without prior knowledge of the generation process or any other processing used.
   Key Feature D1: Process of Incorporating Digital Watermarking into Generated Content, in which the Count of Possible Watermarked Content can be Dynamically Scaled.

Computer implemented process for embedding a digital watermark within generated content, comprising the steps of
(a) generating tokens from input data such as a user prompt using a Generative AI such as an LLM; and
(b) embedding the digital watermark within the set of generated tokens; and
(a) generating content, and in which the digital watermark is chosen or selected based on the prompting user or other parameters of the generation;
   and in which the count of possible watermarked content can be dynamically scaled.

### Optional Features

generated content includes text, images, video and/or audio.

### Process of Embedding the Digital Watermark

The digital watermark is embedded in the set of generated tokens and not in any metadata or redundant data.
Digital watermark pattern is embedded within watermark tokens, in which the watermark tokens are assigned or determined such that their tokens hash to a value that falls within a predefined range of a hash space.
Determining if a generated token should be assigned a watermark token is only a function of the generated token itself, the watermark being embedded, and a secret watermarking key.
Hashing of the tokens is done using a cryptographic hash function based on a secret watermarking key, so an attacker cannot learn within which subspace a token resides.
The process includes the step of endeavouring to return the watermark tokens never or rarely, such that a bin of the hash space contains no value or near zero value.
   Reconstruction or Extraction of the Digital Watermark from a Data Release
The digital watermark can be reconstructed without prior knowledge of the scheme used to generate the tokens.
Digital watermark is reconstructed by (a) hashing the tokens in the content using one or more hash functions, (b) building up a histogram of hash frequency of the hash space, and (c) determining the bin that corresponds to the digital watermark.
When multiple hash functions have been used, the process includes the step of summing the number of hashes for each bin across all of the hash functions.
Each hash function includes a different key.
The process includes the step of calculating a probability of getting an observed number of hashes, or fewer, in a specific bin when the watermarked data release does not include the digital watermark that corresponds to the specific bin
When the calculated probability is lower than a predefined threshold, the process infers that the data release contains a particular digital watermark.
The process allows for the reconstruction of the digital watermark on only a subset of the tokens from the generated content.
The process is able to handle noise, such as the addition, removal or modification of tokens within the content.
The extraction of the digital watermark is associated with a confidence score that relates to the likelihood (a) of the presence of a watermark in the content and (b) that an underrepresented bin within the histogram of token hash counts corresponds to the hash bin (how sure we can be that the watermark is really present in the content and that an underrepresented bin within the histogram of token hash counts isn't just an artefact of random chance).
The process includes the step of estimating the number of tokens needed to reconstruct a digital watermark.
The number of tokens is estimated for a given confidence level and amount of noise present in the content tokens.

### Digital Watermark is Dependent on the Parameters of the Data Release

The computer implemented process includes the step of generating content, and in which the digital watermark is chosen or selected based on the parameters of the input data, prompt or user.
The digital watermark is chosen or selected based on the prompting user. Each content generated in response to the same input data or user prompt may include a different digital watermark.
The digital watermark represents a pattern that is a unique ID.
The process includes the step of dynamically scaling the count of possible watermarked content by updating the hash function.
The process includes the step of dynamically scaling the count of possible watermarked content by hashing the token space with another hash function.
The digital watermark is associated with a timestamp.

### Computer Device or System

A computing device or system adapted to embed a digital watermark within Generative AI Output, the device or system comprising a processor that is configured to:
(a) generate tokens from input data such as a user prompt using a Generative AI such as an LLM; and
(b) embed the digital watermark within the set of generated tokens.

### Use Cases

A computing device or system adapted to detect the use of deepfakes, the device or system comprising a processor that is configured to:
(a) receive content;
(b) hash the tokens in the entire received content or in any subset of received content using one or more hash functions and build up a histogram of hash frequency of the hash space; and
(c) from an analysis of the histogram, determine or estimate if a digital watermark has been embedded within the received content and the likelihood that the received content is a deepfake.

### Optional Features:

Deepfake refers to Generative AI content that has been embedded with a digital watermark using a computer implemented process comprising the steps of (a) generating tokens from input data such as a user prompt using a Generative AI; and (b) embedding the digital watermark within the set of generated tokens.
Detection of the use of deepfakes is associated with a confidence score that relates to the likelihood that the content was produced by a Generative AI.
System is configured to provide an alert or notification when deepfakes have been used.
System is configured to provide an alert or notification when deepfakes have not been used.
System is configured to present deepfakes alongside metrics related to the deepfakes including confidence score, input data or user prompt, type of Generative AI, user ID.
System is configured to automatically remove deepfakes from the content.
System is configured to detect a specific user that used deepfakes based on the digital watermark.
System is configured to automatically block the specific user.
System is configured to automatically detect the use of deepfakes as content is being uploaded onto social media or website or online gaming platform or email.
System is configured to determine or estimate percentage of media content within the social media or email or online gaming system or website that has been produced by a Generative AI.
System is configured to detect the use of deepfakes by analysing only a subset of the generated content.

A social media system configured to detect the use of deepfakes by detecting a digital watermark that has been embedded within social media content.
the system comprising a processor that is configured to: hash tokens in any subset of the social media content using one or more hash functions and build up a histogram of hash frequency of the hash space; and from an analysis of the histogram, determine or estimate if a digital watermark has been embedded within the social media content and the likelihood that the social media content includes a deepfake.

An email system configured to detect the use of deepfakes by detecting a digital watermark that has been embedded within email content.
the system comprising a processor that is configured to: hash tokens in any subset of the email content using one or more hash functions and build up a histogram of hash frequency of the hash space; and from an analysis of the histogram, determine or estimate if a digital watermark has been embedded within the email content and the likelihood that the email content includes a deepfake.

Online gaming system configured to detect the use of deepfakes by detecting a digital watermark that has been embedded within online gaming content.
the system comprising a processor that is configured to: hash tokens in any subset of the online gaming content using one or more hash functions and build up a histogram of hash frequency of the hash space; and from an analysis of the histogram, determine or estimate if a digital watermark has been embedded within the online gaming content and the likelihood that the online gaming content includes a deepfake.

Web browser system configured to detect the use of deepfakes by detecting a digital watermark that has been embedded within website content.
the system comprising a processor that is configured to: hash tokens in any subset of the website content using one or more hash functions and build up a histogram of hash frequency of the hash space; and from an analysis of the histogram, determine or estimate if a digital watermark has been embedded within the website content and the likelihood that the website content includes a deepfake.

### NOTE

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A computer implemented process for generating tokens from a set of input data that includes input values of varying length, in which the process includes the step of generating tokens from the set of input data, the tokens having lengths that exhibit a substantially similar statistical distribution as the distribution of lengths of the set of input data, wherein the similar statistical distribution is achieved by assigning token lengths using a distribution constructed from the observed input data length distribution.

2. The computer implemented process of claim 1, in which the length of a token is not necessarily matched to the length of its corresponding input value.

3. The computer implemented process of claim 1, in which the tokens are generated using an encryption scheme that treats each subset of the input data corresponding to a specific length of input values as a separate or distinct format preserving encryption.

4. The computer implemented process of claim 1, in which for each subset of the input data corresponding to a specific length of input values, tokens are generated with varying lengths.

5. The computer implemented process of claim 1, in which for each subset of the input data corresponding to a specific length of input values, tokens are generated with varying lengths, in which the generated tokens have length that conform to some chosen distribution generated for that specific length.

6. The computer implemented process of claim 1, in which once tokens are generated from the subset of the input data corresponding to that specific length of input values, an additional format preserving encryption is used on the generated tokens.

7. The computer implemented process of claim 1, in which tokens are generated based on one or more user-configurable parameter, including a minimum token length, a maximum token length or the distribution used to assign token length according to weightings values.

8. A computer implemented process for embedding a digital watermark within tokenised data, the process comprising the steps of
(a) generating tokens from a set of input data that includes input values of varying length, in which tokens are generated with lengths that exhibit a substantially similar statistical distribution as the distribution of lengths of the set of input data, wherein the similar statistical distribution is achieved by assigning token lengths using a distribution constructed from the observed input data length distribution, and
(b) during the token generation process, embedding the digital watermark within the set of generated tokens.

9. The computer implemented process of claim 8, in which the length of a token is not necessarily matched to the length of its corresponding input value.

10-11. (canceled)

12. The computer implemented process of claim 8, in which for each subset of the input data corresponding to a specific length of input values, tokens are generated with varying lengths, in which the generated tokens have length that conform to some chosen distribution generated for that specific length.

13. The computer implemented process of claim 8, in which once tokens are generated from the subset of the input data corresponding to that specific length of input values, an additional format preserving encryption is used on the generated tokens.

14. The computer implemented process of claim 8, in which tokens are generated based on one or more user-configurable parameter, including a minimum token length, a maximum token length or the distribution to use to assign token length weightings.

15. The computer implemented process of claim 8, in which the digital watermark includes a pattern that is probabilistically embedded through a choice of tokens within the set of generated tokens.

16. The computer implemented process of claim 8, in which the digital watermark can be reconstructed without prior knowledge of an encryption scheme or any other processing used on the set of input data.

17-18. (canceled)

19. The computer implemented process of claim 8, in which the process includes the steps of:
(a) scanning or observing an input space that corresponds to the set of input data,
(b) determining or identifying the inputs that should be mapped to watermark tokens.

20-23. (canceled)

24. The computer implemented process of claim 8, in which the digital watermark pattern is embedded within watermark tokens, in which the watermark tokens are assigned or determined such that their tokens hash to a value that falls within a predefined range of a hash space.

25. The computer implemented process of claim 8, in which hashing of the tokens is done using a cryptographic hash function based on a secret watermarking key, so an attacker cannot learn within which subspace a token resides.

26-33. (canceled)

34. The computer implemented process of claim 8, in which the digital watermark is reconstructed by (a) hashing the tokens in the data release using one or more hash functions, (b) building up a histogram of hash frequency of the hash space, and (c) determining the bin that corresponds to the digital watermark.

35. (canceled)

36. The computer implemented process of claim 8, in which each hash function includes a different key.

37. The computer implemented process of claim 8, in which the process includes the step of calculating a probability of getting an observed number of hashes, or fewer, in a specific bin when the watermarked data release does not include the digital watermark that corresponds to the specific bin, and in which when the calculated probability is lower than a predefined threshold, the process infers that the data release contains a particular digital watermark.

38. (canceled)

39. The computer implemented process of claim 8, in which the process allows for the reconstruction of the digital watermark on only a subset of a data release.

40. The computer implemented process of claim 8, in which the process is able to handle noise, including the addition or removal of rows of the data release.

41. The computer implemented process of claim 8, in which the extraction of the digital watermark is associated with a confidence score that relates to the likelihood (a) of the presence of a watermark in the tokenised data and (b) that an underrepresented bin within the histogram of token hash counts corresponds to the hash bin.

42-53. (canceled)

54. A computing system adapted to generate tokens from a set of input data that includes input values of varying length, the device or system comprising a processor that is configured to generate tokens from the set of input data, the tokens having lengths that exhibit a substantially similar statistical distribution as the distribution of lengths of the set of input data, wherein the similar statistical distribution is achieved by assigning token lengths using a distribution constructed from the observed input data length distribution.

55. (canceled)
